(19) United States
(12) Patent Application Publication
(10) Pub. No.: US 2025/0230272 A1
(43) Pub. Date: Jul. 17, 2025

(54) MATERIALS FOR FREE-RADICAL ACTIVATION OF A LATENT CATALYST FOR RING-OPENING METATHESIS POLYMERIZATION (ROMP) AND USES THEREOF

(71) Applicant: Inkbit, LLC, Medford, MA (US)

(72) Inventors: Zachary P. NELSON, Cambridge, MA (US); Scott T. TWIDDY, Everett, MA (US)

(21) Appl. No.: 18/855,829

(22) PCT Filed: Apr. 13, 2023
(86) PCT No.: PCT/US2023/065738

§ 371 Date: Oct. 10, 2024

Related U.S. Application Data
(60) Provisional application No. 63/330,736, filed on Apr. 13, 2022.
(60) Provisional application No. 63/330,738, filed on Apr. 13, 2022.

(51) Int. Cl. C08G 61/08; B29C 64/129; B33Y 10/00; B33Y 70/00

(52) U.S. Cl. CPC C08G 61/08; B29C 64/129; B33Y 10/00; B33Y 70/00; C08G 2261/3325; C08G 2261/374; C08G 2261/418

(57) ABSTRACT

The present disclosure relates to materials for radical-initiated activation of a latent catalyst for ring-opening metathesis polymerization (ROMP). The present disclosure also relates to uses of the materials, e.g., in 3D printing.

### CROSS REFERENCE TO RELATED APPLICATIONS

This application claims the benefit of U.S. Provisional Application No. 63/330,736 filed Apr. 13, 2022 and U.S. Provisional Application No. 63/330,738 filed Apr. 13, 2022, which are incorporated herein by reference.

### BACKGROUND

Additive manufacturing, also known as 3D printing, refers to a relatively wide class of techniques that allows objects to be fabricated via selective addition of material according to a computer-controlled process, generally to match a desired 3D specification, for example, a solid model. A number of different classes of materials have been used for such 3D printing, with different materials providing corresponding advantages and/disadvantages for different fabrication techniques. For example, a survey of materials may be found in Ligon et al. (Chemical Reviews 117(15):10212-10290 (2017)).

The activation of latent homogeneous catalysts by external stimuli finds use in many critical industrial polymerization processes such as 3D printing. Among considerations for developing technologies using latent homogenous catalysts are cost, speed of activation, speed of polymerization, latency, and final material properties. In general trade-offs exist between these considerations. A class of fabrication techniques jets material for deposition on a partially fabricated object using inkjet printing technologies. The jetted material is typically UV cured shortly after it is deposited, forming thin layers of cured material. To achieve precision fabrication, some techniques use mechanical approaches to maintain accurate layer-to-layer structure, for example, using mechanical rollers or “planarizers” to control the surface geometry, and therefore control the accuracy of the fabricated object. Therefore, rapid curing is a key feature to allow the planarization and obtain an accurately fabricated object. However, the resulting material properties obtained with such inks may be insufficient.

### SUMMARY

In some aspects, the present disclosure provides a combination comprising:
(i) a ring-opening-metathesis-polymerization (ROMP) precursor;
(ii) a curing catalyst; and
(iii) a free radical initiator.

In some aspects, the present disclosure provides a build material comprising a combination disclosed herein.

In some aspects, the present disclosure provides a kit comprising a combination disclosed herein.

In some aspects, the present disclosure provides a method of preparing a cured material, comprising a step of subjecting a combination, build material, or kit disclosed herein to a curing condition.

In some embodiments, the build curing condition comprises irradiation (e.g., visible light or UV).

In some aspects, the present disclosure provides a system for 3D printing, comprising:
(i) a printer (e.g., an inkjet printer); and
(ii) an ink comprising a combination disclosed herein.

### BRIEF DESCRIPTION OF THE DRAWINGS

FIG. 1 is a schematic diagram of an exemplary 3D printer.

FIG. 2 is a schematic diagram of an alternative exemplary 3D printer.

### DETAILED DESCRIPTION

To achieve the high latency and rapid polymerization desired for applications such as 3D printing, reactive injection molding, and others, polymers such as UV-cure epoxies, UV-cure acrylates polyurethanes, polyureas, polyisocyanurates, polyesters, and polyphenols are typically used. Cyclic olefin polymers generated by Ring-Opening Metathesis (ROMP) can possess superior properties for many applications. However, the applications of ROMP technology can be limited due to its rapid curing at ambient conditions (e.g., room temperature). Typically, a formulation polymerizable by ROMP immediately solidifies once a catalyst is added. This limits the use of ROMP formulations in 3D inkjet processes, where liquid formulations that feature viscosities within a pre-determined range are required to be passed through inkjet printing heads. Latent metathesis catalysts are an important class of catalysts that require the application of an external stimulus in order to promote metathesis reactions, and thus may be employed to ensure suitable stability of the formulation under ambient conditions. However, current ROMP polymerization methods can suffer from poor latency, slow cure times, or both. Without wishing to be bound by theory, for many monomers polymerized using ROMP, especially strained cyclic olefins, initiation of the latent metathesis catalyst is the rate determining step, and therefore slow catalyst initiation can lead to slow cure times overall.

In addition, in inkjet printing, low viscosity (e.g., 0.5-150 cP at 90° C.), low surface tension (e.g., 20-45 mN/m) and low particulate size (e.g., filterable through a 3 μm filter) are highly desirable. Furthermore, inkjet 3D printers and similar techniques rely on the formation of small, high surface-area droplets; many common polymerization components, such as dicyclopentadiene (DCPD), may be unsuitable for inkjet printing, due to their low flash points and the hot surfaces and electronic components in such printers (without wishing to be bound by theory, droplets of a flammable liquid can be more flammable than bulk liquid of the same chemical composition). On the other hand, many polymerizable compositions developed for other 3D printing methods, such as stereolithography (SLA), may possess properties which are unnecessary or detrimental in inkjet printing, such as selective photo inhibitors needed to prevent polymerization outside the desired print area.

Leguizamon et al. disclosed a composition comprising DCPD, a latent ruthenium catalyst and isopropyl thioxanthone (ITX), which is described as a photosensitizer, which possessed faster ROMP initiation rates, and lower overall cure times, than previously achieved. ACS Appl. Polym. Mater. 2019, 1, 8, 2177-2188. When combined with hydrophobic fumed silica, this rapid cure composition enabled relatively fast 3D printing by UV-cured direct ink write (DIW). However, the viscosity of such a composition used in their demonstration (usually ≥1000 cP) renders it impractical for use in inkjet printing.

There is a need for novel compositions for ROMP that possess most or all of the beneficial characteristics for various 3D printing methods (e.g., inkjet 3D printing), such as high overall polymerization speed, high latency, low viscosity, low particulate content, high flash point, and the like. The present disclosure addresses this need.

Without wishing to be bound by theory, the present disclosure relates to the discovery of novel materials for ring opening metathesis polymerization (ROMP). Such materials may be suitable for being used as ink for 3D printing. In some embodiments, the materials may allow for a 3D printing process that does not require any contact to control the surface geometry of the object being printed, e.g., a 3D printing process using a non-contact (e.g., optical) feedback approach.

Many of the leading photo-activated ROMP systems utilize photoacid generators to activate latent ruthenium ROMP catalysts, e.g., U.S. Pat. No. 10,675,614. Without wishing to be bound by theory, such ROMP systems may be oxygen sensitive, possibly due to interception of radical intermediates during the generation of the photoacid. The compositions disclosed herein may be less oxygen sensitive than those employing a photoacid generator. In some embodiments, the methods disclosed herein are not carried out in an inert atmosphere.

Suitable applications and systems for the materials of the present disclosure are described, e.g., in U.S. Provisional Appl'n No. 62/777,422 and PCT Appl'n No. PCT/US2019/065436 (incorporated herein by reference).

In some 3D printing techniques, the building of a three-dimensional object is performed in a step-wise or layer-wise manner. In particular, layer formation is performed by solidification of a photocurable resin under irradiation of visible light or UV light. Commonly referred to as “stereolithography”, two particular techniques are known: a new layer is formed on the top surface of the grown object; the other forms a new layer on the bottom surface of the grown object. Examples of such methods include those given in U.S. Pat. Nos. 5,236,637.S. 5,391,072 5,529,473 7,438,846 7,892,474 and 8,110,135

More recently, a technique known as “continuous liquid interface manufacturing” (or “CLIP”) has been developed. This technique enables the rapid fabrication of three-dimensional objects in a non-layered manner by which components can have desirable structural and mechanical properties. See, e.g., U.S. Pat. Nos. 9,211,678, 9,205,601, and 9,216,546), J. Tumbleston et al, Continuous liquid interface production of 3D Objects, Science 347, 1349-1352, and Janusziewicz, Rima et al. “Layerless fabrication with continuous liquid interface production.” Proc Natl Acad Sci USA vol. 113, 42 (2016): 11703-11708.

Binder jetting is an additive manufacturing technique based on the use of a liquid binder to join particles of a powder to form a three-dimensional object. In particular, a controlled pattern of the liquid binder is applied to successive layers of the powder in a powder bed such that the layers of the powder adhere to one another form a three-dimensional object. The three-dimensional object is then densified into a finished part through subsequent processing, such as sintering.

Volumetric additive manufacturing (AM) is a recently developed concept. For example, see the work of Loterie, Damien, Paul Delrot, and Christophe Moser, “VOLUMETRIC 3D PRINTING OF ELASTOMERS BY TOMOGRAPHIC BACK-PROJECTION” https://www.researchgate.net/publication/328956954 (2018). Another example of volumetric AM is Kelly, Brett E., Indrasen Bhattacharya, Hossein Heidari, Maxim Shusteff, Christopher M. Spadaccini, and Hayden K. Taylor, “Volumetric additive manufacturing via tomographic reconstruction,” Science 363, no. 6431 (2019): 1075-1079. Volumetric AM has shown significant promise in accelerating the rate of polymer-based additive manufacturing, among many other benefits. Volumetric printing is carried out over a 3D volume simultaneously rather than building up a 3D structure (i.e., part or component) via scanned point or 2D-surface curing operations.

Reactive injection molding is the formation of objects by injecting resin into a mold, and then curing within the mold. Many types of polymers and polymeric objects can be manufactured via reactive injection molding, including polyurethanes, polyamides, polyesters, and/or molded thermosets. Process variables that can be manipulated during reactive injection molding include cure speed, ease of initiation, stability of precursor resins, thermal management, and additives used to control these properties.

The reactive injection molding of cyclic olefin resins via ROMP can be used in the manufacturing of functional parts that require extreme toughness, chemical resistance, heat resistance, and light weight. Examples include hoods, wind deflectors, and fasciae for heavy truck and agricultural and industrial equipment. Examples of commercial cyclic olefin products produced via ROMP include Telene®, Pentam®, Metton®, Cyonyx®, Prometa®, Norsorex®, Zeonex®, Zeonor®, and Arton®. The use of ROMP reactions in reaction injection molding (RIM) has been described, for example, in U.S. Patent Application Publication Nos. 2011/0171147, and U.S. Pat. No. 8,487,046.

ROMP processes described herein may have several advantages to other existing technologies. There are several advantages associated with the use of latent catalysts in general, which may be activated chemically, thermally, or with light. The use of latent catalysts may allow for the polymerizing resin to cure or not cure at a rate that suits each step of the RIM process. Latent catalysts can increase the working time (i.e., how long one can spend filling the mold before the viscosity of the material becomes too high) and decreasing the amount of time or heating required to cure the object.

Without wishing to be bound by theory, compared with standard techniques, in which the catalyst is chemically activated with acid or copper ions, ROMP processes described herein can be less corrosive toward the walls of the mold (which can be metallic) and less sensitive to oxygen. The high rate of initiation in the ROMP processes described herein may lead to polymers with a lower overall dispersity, which is a widely used method for maximizing the mechanical properties of the final cured material. Additionally, the ability to use thermal radical initiators, which have well known thermal decomposition temperatures and kinetics, may allow the system to have more easily tunable thermal and kinetic initiation properties than would be possible through costly and difficult catalyst tuning.

Coatings modify the surface characteristics of a material, for the purpose of making the surface more wear resistant, UV resistant, chemical resistant, hydrophobic, hydrophilic, colored, less oxygen permeable, and other properties. Cyclic olefin polymers prepared via ROMP are especially suitable in the fabrication of tough and wear-resistant coatings. Using a photomask, catalyst activation can be confined to regions irradiated with light

Embodiments described herein can be advantageous to coatings applications due to the fast catalyst activation and fast overall curing kinetics. These properties can reduce processing times and likely lead to tougher overall materials than competing processes. Without wishing to be bound by theory, the compositions described herein may be less oxygen sensitive than comparable compositions without a radical initiator, which may be a significant advantage over photoacid generator-based catalyst activation strategies in this context due to the bulk of the thin coating suffering from a low degree of cure.

The compositions herein may also be advantageous for the manufacture of adhesives and dental fillings, in which a fast-curing resin with high post-curing toughness can be advantageous.

### Combinations, Materials, and Kits of the Present Disclosure

In some aspects, the present disclosure provides a combination comprising:
(i) a ring-opening-metathesis-polymerization (ROMP) precursor;
(ii) a curing catalyst; and
(iii) a free radical initiator.

In some aspects, the present disclosure provides a combination comprising:
(i) a ring-opening-metathesis-polymerization (ROMP) precursor;
(ii) a curing catalyst;
(iii) a free radical initiator; and
(iv) an antioxidant.

In some aspects, the present disclosure provides a build material comprising a combination disclosed herein.

In some aspects, the present disclosure provides a kit comprising:
a first build material comprising:
   (i) a ROMP precursor; and
   (ii) a curing catalyst;
a second build material comprising:
   (iii) a ROMP precursor; and
   (iv) a free radical initiator; and
a support material.

In some aspects, the present disclosure provides a kit comprising:
a first build material comprising
   (i) a ROMP precursor; and
   (ii) a free radical initiator
a second build material comprising
   (iii) a curing catalyst; and
   (iv) an inert solvent; and
A support material.

In some aspects, the present disclosure provides a kit comprising:
a first build material comprising
   (i) a ROMP precursor; and
a second build material comprising
   (ii) a free radical initiator
   (iii) a curing catalyst; and
   (iv) an inert solvent; and
A support material.

In some aspects, the present disclosure provides a kit comprising:
a first build material comprising:
   (i) a ROMP precursor; and
   (ii) a curing catalyst;
a second build material comprising:
   (iii) a ROMP precursor; and
   (iv) a free radical initiator.

In some aspects, the present disclosure provides a kit comprising:
a first build material comprising
   (i) a ROMP precursor; and
   (ii) a free radical initiator
a second build material comprising
   (iii) a curing catalyst; and
   (iv) an inert solvent.

In some aspects, the present disclosure provides a kit comprising:
a first build material comprising
   (i) a ROMP precursor; and
a second build material comprising
   (ii) a free radical initiator
   (iii) a curing catalyst; and
   (iv) an inert solvent.

In some aspects, the present disclosure provides a kit comprising:
a first build material comprising
   (i) a ROMP precursor; and
   (ii) a free radical initiator
a second build material comprising
   (iii) a curing catalyst; and
   (iv) an antioxidant; and
a support material.

In some aspects, the present disclosure provides a kit comprising:
a first build material comprising
   (i) a ROMP precursor; and
a second build material comprising
   (ii) a free radical initiator
   (iii) a curing catalyst; and
   (iv) an antioxidant; and
a support material.

In some aspects, the present disclosure provides a kit comprising a combination disclosed herein.

In some aspects, the present disclosure provides a kit comprising:
a first build material comprising:
   (i) a ROMP precursor; and
   (ii) a curing catalyst; and
a second build material comprising:
   (iii) a ROMP precursor; and
   (iv) a free radical initiator.

In some aspects, the present disclosure provides a kit comprising:
a first build material comprising
   (i) a ROMP precursor; and
   (ii) a free radical initiator
a second build material comprising
   (iii) a curing catalyst; and
   (iv) an antioxidant.

In some aspects, the present disclosure provides a kit comprising:
a first build material comprising
   (i) a ROMP precursor; and
a second build material comprising
   (ii) a free radical initiator
   (iii) a curing catalyst; and
   (iv) an antioxidant.

In some aspects, the present disclosure provides a kit comprising:
a build material comprising:
   (i) a ROMP precursor; and
   (ii) a curing catalyst; and
a support material.

In some aspects, the present disclosure provides a kit comprising:
a build material comprising:
   (i) a ROMP precursor;
   (ii) a curing catalyst; and
   (iii) a free radical initiator; and
a support material.

It is understood that, for a combination, build material, or kit described herein, the ROMP precursor, curing catalyst, activator, antioxidant, and support material can each be, where applicable, selected from the groups described herein, and any group described herein for any of ROMP precursor, curing catalyst, activator, antioxidant, catalyst inhibitor, optical enhancement component, stabilizer, impact modifier, pigment, dye, surface active agent, filler, dispersant and or support material can be combined, where applicable, with any group described herein for one or more of the remainder of ROMP precursor, curing catalyst, activator, antioxidant, catalyst inhibitor, optical enhancement component, stabilizer, impact modifier, pigment, dye, surface active agent, filler, dispersant and or support material.

### 2D Printing

2D printing can be considered a similar process to 3D printing, but stopping after the first layer. Different cured properties are more or less desirable, depending on the number of dimensions being printed. However, the process and materials employed can be similar.

### ROMP Precursors

In some embodiments, the ROMP precursor is a compound of Formula (M-I):

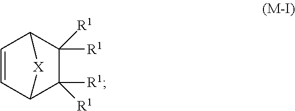

or a salt thereof, wherein:
X is CH₂ or O;
each R¹ independently:
   (a) is H, halogen, cyano, —OR^{1A}, —SR^{1A}, —C(═O)—R^{1A}, —C(═O)—OR^{1A}, —O—C(═O)—R^{1A}, —C(═O)—N(R^{1A})₂, —C(═O)—NHR^{1A}, —NH—C(═O)—R^{1A}, —N(R^{1A})₂, —Si(R^{1A})₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1A}; or
   (b) together with another R¹ and the atoms to which they attach, form a bond, C₃-C₂₀ cycloalkyl, C₆-C₂₀ aryl, 3- to 20-membered heterocycloalkyl, or 5- to 20-membered heteroaryl, wherein the C₃-C₂₀ cycloalkyl, C₆-C₂₀ aryl, 3- to 20-membered heterocycloalkyl, or 5- to 20-membered heteroaryl is optionally substituted with one or more R^{1A};
each R^{1A} independently:
   (a) is H, halogen, cyano, —OR^{1B}, —SR^{1B}, —C(═O)—R^{1B}, —C(═O)—OR^{1B}, —O—C(═O)—R^{1B}, —C(═O)—N(R^{1B})₂, —C(═O)—NHR^{1B}, —NH—C(═O)—R^{1B}, —N(R^{1B})₂, —Si(R^{1B})₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1B}; or
   (b) together with another R^{1A} and the atoms to which they attach, form a bond, C₃-C₂₀ cycloalkyl, C₆-C₂₀ aryl, 3- to 20-membered heterocycloalkyl, or 5- to 20-membered heteroaryl, wherein the C₃-C₂₀ cycloalkyl, C₆-C₂₀ aryl, 3- to 20-membered heterocycloalkyl, or 5- to 20-membered heteroaryl is optionally substituted with one or more R^{1B};
each R^{1B} independently is H, halogen, cyano, —OR^{1C}, —SR^{1C}, —C(═O)—R^{1C}, —C(═O)—OR^{1C}, —O—C(═O)—R^{1C}, —C(═O)—N(R^{1C})₂, —C(═O)—NHR^{1C}, —NH—C(═O)—R^{1C}, —N(R^{1C})₂, —Si(R^{1C})₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1C};
each R^{1C} independently is H, halogen, cyano, —OR^{1D}, —SR^{1D}, —C(═O)—R^{1D}, —C(═O)—OR^{1D}, —O—C(═O)—R^{1D}, —C(═O)—N(R^{1D})₂, —C(═O)—NHR^{1D}, —NH—C(═O)—R^{1D}, —N(R^{1D})₂, —Si(R^{1D})₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1D}; and
each R^{1D} independently is H, halogen, cyano, —OH, —NH₂, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl.

### Variable X

In some embodiments, X is CH₂.

In some embodiments, X is O.

### Variable R¹

In some embodiments, at least one R¹ is H, halogen, cyano, —OR^{1A}, —SR^{1A}, —C(═O)—RA, —C(═O)—OR^{1A}, —O—C(═O)—R^{1A}, —C(═O)—N(R^{1A})₂, —C(═O)—NHR^{1A}, —NH—C(═O)—R^{1A}, —N(R^{1A})₂, —Si(R^{1A})₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1A}.

In some embodiments, at least one R¹ is H.

In some embodiments, at least one R¹ is halogen, cyano, —OR^{1A}, —SR^{1A}, —C(═O)—R^{1A}, —C(═O)—OR^{1A}, —O—C(═O)—R^{1A}, —C(═O)—N(R^{1A})₂, —C(═O)—NHR^{1A}, —NH—C(═O)—R^{1A}, —N(R^{1A})₂, —Si(R^{1A})₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1A}.

In some embodiments, at least one R¹ is halogen.

In some embodiments, at least one R¹ is cyano.

In some embodiments, at least one R¹ is —OR^{1A}.

In some embodiments, at least one R¹ is —SR^{1A}.

In some embodiments, at least one R¹ is —C(═O)—R^{1A}.

In some embodiments, at least one R¹ is —C(═O)—OR^{1A}.

In some embodiments, at least one R¹ is —O—C(═O)—R^{1A}.

In some embodiments, at least one R¹ is —C(═O)—N(R^{1A})₂.

In some embodiments, at least one R¹ is —C(═O)—NHR^{1A}.

In some embodiments, at least one R¹ is —NH—C(═O)—R^{1A}.

In some embodiments, at least one R¹ is —N(R^{1A})₂.

In some embodiments, at least one R¹ is —Si(R^{1A})₃.

In some embodiments, at least one R¹ is C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1A}.

In some embodiments, at least one R¹ is C₁-C₂₀ alkyl optionally substituted with one or more R^{1A}.

In some embodiments, at least one R¹ is C₂-C₂₀ alkenyl optionally substituted with one or more R^{1A}.

In some embodiments, at least one R¹ is C₂-C₂₀ alkynyl optionally substituted with one or more R^{1A}.

In some embodiments, at least one R¹ is C₃-C₂₀ cycloalkyl optionally substituted with one or more R^{1A}.

In some embodiments, at least one R¹ is C₆-C₂₀ aryl (e.g., phenyl) optionally substituted with one or more R^{1A}.

In some embodiments, at least one R¹ is 3- to 20-membered heterocycloalkyl optionally substituted with one or more R^{1A}.

In some embodiments, at least one R¹ is 5- to 20-membered heteroaryl optionally substituted with one or more R^{1A}.

In some embodiments, at least two R¹, together with the atoms to which they attach, form a bond, C₃-C₂₀ cycloalkyl, C₆-C₂₀ aryl, 3- to 20-membered heterocycloalkyl, or 5- to 20-membered heteroaryl, wherein the C₃-C₂₀ cycloalkyl, C₆-C₂₀ aryl, 3- to 20-membered heterocycloalkyl, or 5- to 20-membered heteroaryl is optionally substituted with one or more R^{1A}.

In some embodiments, at least two R¹, together with the atoms to which they attach, form a bond.

In some embodiments, at least two R¹, together with the atoms to which they attach, form C₃-C₂₀ cycloalkyl, C₆-C₂₀ aryl, 3- to 20-membered heterocycloalkyl, or 5- to 20-membered heteroaryl, wherein the C₃-C₂₀ cycloalkyl, C₆-C₂₀ aryl, 3- to 20-membered heterocycloalkyl, or 5- to 20-membered heteroaryl is optionally substituted with one or more R^{1A}.

In some embodiments, at least two R¹, together with the atoms to which they attach, form C₃-C₂₀ cycloalkyl optionally substituted with one or more R^{1A}.

In some embodiments, at least two R¹, together with the atoms to which they attach, form C₆-C₂₀ aryl (e.g., phenyl) optionally substituted with one or more R^{1A}.

In some embodiments, at least two R¹, together with the atoms to which they attach, form 3- to 20-membered heterocycloalkyl optionally substituted with one or more R^{1A}.

In some embodiments, at least two R¹, together with the atoms to which they attach, form 5- to 20-membered heteroaryl optionally substituted with one or more R^{1A} Variable R^{1A}.

In some embodiments, at least one R^{1A} is H.

In some embodiments, at least one R^{1A} is halogen, cyano, —OR^{1B}, —SR^{1B}, —C(═O)—R^{1B}, —C(═O)—OR^{1B}, —O—C(═O)—R^{1B}, —C(═O)—N(R^{1B})₂, —C(═O)—NHR^{1B}, —NH—C(═O)—R^{1B}, —N(R^{1B})₂, —Si(R^{1B})₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more RB.

In some embodiments, at least one R^{1A} is halogen.

In some embodiments, at least one R^{1A} is cyano.

In some embodiments, at least one R^{1A} is —OR^{1B}.

In some embodiments, at least one R^{1A} is —SR^{1B}.

In some embodiments, at least one R^{1A} is —C(═O)—R^{1B}.

In some embodiments, at least one R^{1A} is —C(═O)—OR^{1B}.

In some embodiments, at least one R^{1A} is —O—C(═O)—R^{1B}.

In some embodiments, at least one R^{1A} is —C(═O)—N(R^{1B})₂.

In some embodiments, at least one R^{1A} is —C(═O)—NHR^{1B}.

In some embodiments, at least one R^{1A} is —NH—C(═O)—R^{1B}.

In some embodiments, at least one R^{1A} is —N(R^{1B})₂.

In some embodiments, at least one R^{1A} is —Si(R^{1B})₃.

In some embodiments, at least one R^{1A} is C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1B}.

In some embodiments, at least one R^{1A} is C₁-C₂₀ alkyl optionally substituted with one or more R^{1B}.

In some embodiments, at least one R^{1A} is C₂-C₂₀ alkenyl optionally substituted with one or more R^{1B}.

In some embodiments, at least one R^{1A} is C₂-C₂₀ alkynyl optionally substituted with one or more R^{1B}.

In some embodiments, at least one R^{1A} is C₃-C₂₀ cycloalkyl optionally substituted with one or more R^{1B}.

In some embodiments, at least one R^{1A} is C₆-C₂₀ aryl (e.g., phenyl) optionally substituted with one or more R^{1B}.

In some embodiments, at least one R^{1A} is 3- to 20-membered heterocycloalkyl optionally substituted with one or more R^{1B}.

In some embodiments, at least one R^{1A} is 5- to 20-membered heteroaryl optionally substituted with one or more R^{1B}.

In some embodiments, at least two R^{1A}, together with the atoms to which they attach, form a bond, C₃-C₂₀ cycloalkyl, C₆-C₂₀ aryl, 3- to 20-membered heterocycloalkyl, or 5- to 20-membered heteroaryl, wherein the C₃-C₂₀ cycloalkyl, C₆-C₂₀ aryl, 3- to 20-membered heterocycloalkyl, or 5- to 20-membered heteroaryl is optionally substituted with one or more R^{1B}.

In some embodiments, at least two R¹, together with the atoms to which to which they attach, form a bond.

In some embodiments, at least two R¹, together with the atoms to which they attach, form C₃-C₂₀ cycloalkyl, C₆-C₂₀ aryl, 3- to 20-membered heterocycloalkyl, or 5- to 20-membered heteroaryl, wherein the C₃-C₂₀ cycloalkyl, C₆-C₂₀ aryl, 3- to 20-membered heterocycloalkyl, or 5- to 20-membered heteroaryl is optionally substituted with one or more R^{1B}.

In some embodiments, at least two R^{1A}, together with the atoms to which they attach, form C₃-C₂₀ cycloalkyl optionally substituted with one or more R^{1B}.

In some embodiments, at least two R^{1A}, together with the atoms to which they attach, form C₆-C₂₀ aryl (e.g., phenyl) optionally substituted with one or more R^{1B}.

In some embodiments, at least two R^{1A}, together with the atoms to which they attach, form 3- to 20-membered heterocycloalkyl optionally substituted with one or more R^{1B}.

In some embodiments, at least two R^{1A}, together with the atoms to which they attach, form 5- to 20-membered heteroaryl optionally substituted with one or more R^{1B}.

### Variable R^{1B}

In some embodiments, at least one R^{1B} is halogen.

In some embodiments, at least one R^{1B} is cyano.

In some embodiments, at least one R^{1B} is —OR^{1C}.

In some embodiments, at least one R^{1B} is —SR^{1C}.

In some embodiments, at least one R^{1B} is —C(═O)—R^{1C}.

In some embodiments, at least one R^{1B} is —C(═O)—OR^{1C}.

In some embodiments, at least one R^{1B} is —O—C(═O)—R^{1C}.

In some embodiments, at least one R^{1B} is —C(═O)—N(R^{1C})₂.

In some embodiments, at least one R^{1B} is —C(═O)—NHR^{1C}.

In some embodiments, at least one R^{1B} is —NH—C(═O)—R^{1C}.

In some embodiments, at least one R^{1B} is —N(R^{1C})₂.

In some embodiments, at least one R^{1B} is —Si(R^{1C})₃.

In some embodiments, at least one R^{1B} is C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1C}.

In some embodiments, at least one R^{1B} is C₁-C₂₀ alkyl optionally substituted with one or more R^{1C}.

In some embodiments, at least one R^{1B} is C₂-C₂₀ alkenyl optionally substituted with one or more R^{1C}.

In some embodiments, at least one R^{1B} is C₂-C₂₀ alkynyl optionally substituted with one or more R^{1C}.

In some embodiments, at least one R^{1B} is C₃-C₂₀ cycloalkyl optionally substituted with one or more R^{1C}.

In some embodiments, at least one R^{1B} is C₆-C₂₀ aryl (e.g., phenyl) optionally substituted with one or more R^{1C}.

In some embodiments, at least one R^{1B} is 3- to 20-membered heterocycloalkyl optionally substituted with one or more R^{1C}.

In some embodiments, at least one R^{1B} is 5- to 20-membered heteroaryl optionally substituted with one or more R^{1C} Variable R^{1C}.

In some embodiments, at least one R^{1C} is halogen.

In some embodiments, at least one R^{1C} is cyano.

In some embodiments, at least one R^{1C} is —OR^{1D}.

In some embodiments, at least one R^{1C} is —SR^{1D}.

In some embodiments, at least one R^{1C} is —C(═O)—R^{1D}.

In some embodiments, at least one R^{1C} is —C(═O)—OR^{1D}.

In some embodiments, at least one R^{1C} is —O—C(═O)—R^{1D}.

In some embodiments, at least one R^{1C} is —C(═O)—N(R^{1D})₂.

In some embodiments, at least one R^{1C} is —C(═O)—NHR^{1D}.

In some embodiments, at least one R^{1C} is —NH—C(═O)—R^{1D}.

In some embodiments, at least one R^{1C} is —N(R^{1D})₂.

In some embodiments, at least one R^{1C} is —Si(R^{1D})₃.

In some embodiments, at least one R^{1C} is C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1D}.

In some embodiments, at least one R^{1C} is C₁-C₂₀ alkyl optionally substituted with one or more R^{1D}.

In some embodiments, at least one R^{1C} is C₂-C₂₀ alkenyl optionally substituted with one or more R^{1D}.

In some embodiments, at least one R^{1C} is C₂-C₂₀ alkynyl optionally substituted with one or more R^{1D}.

In some embodiments, at least one R^{1C} is C₃-C₂₀ cycloalkyl optionally substituted with one or more R^{1D}.

In some embodiments, at least one R^{1C} is C₆-C₂₀ aryl (e.g., phenyl) optionally substituted with one or more R^{1D}.

In some embodiments, at least one R^{1C} is 3- to 20-membered heterocycloalkyl optionally substituted with one or more R^{1D}.

In some embodiments, at least one R^{1C} is 5- to 20-membered heteroaryl optionally substituted with one or more R^{1D}.

### Variable R^{1D}

In some embodiments, at least one R^{1D} is H.

In some embodiments, at least one R^{1D} is halogen, cyano, —OH, —NH₂, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl.

In some embodiments, at least one R^{1D} is halogen.

In some embodiments, at least one R^{1D} is cyano.

In some embodiments, at least one R^{1D} is —OH.

In some embodiments, at least one R^{1D} is —NH₂.

In some embodiments, at least one R^{1D} is C₁-C₂₀ alkyl.

In some embodiments, at least one R^{1D} is C₂-C₂₀ alkenyl.

In some embodiments, at least one R^{1D} is C₂-C₂₀ alkynyl.

In some embodiments, at least one R^{1D} is C₃-C₂₀ cycloalkyl.

In some embodiments, at least one R^{1D} is C₆-C₂₀ aryl (e.g., phenyl).

In some embodiments, at least one R^{1D} is 3- to 20-membered heterocycloalkyl.

In some embodiments, at least one R^{1D} is 5- to 20-membered heteroaryl.

It is understood that, for a compound of Formula (M-I), X, R¹, R^{1A}, R^{1B}, R^{1C}, and R^{1D} can each be, where applicable, selected from the groups described herein, and any group described herein for any of X, R¹, R^{1A}, R^{1B}, R^{1C}, and R^{1D} can be combined, where applicable, with any group described herein for one or more of the remainder X, R¹, R^{1A}, R^{1B}, R^{1C}, and R^{1D}.

### Exemplary ROMP Precursors

In some embodiments, the ROMP precursor is a compound of:

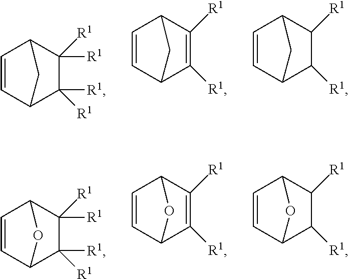

or a salt thereof.

In some embodiments, the ROMP precursor is a compound of:

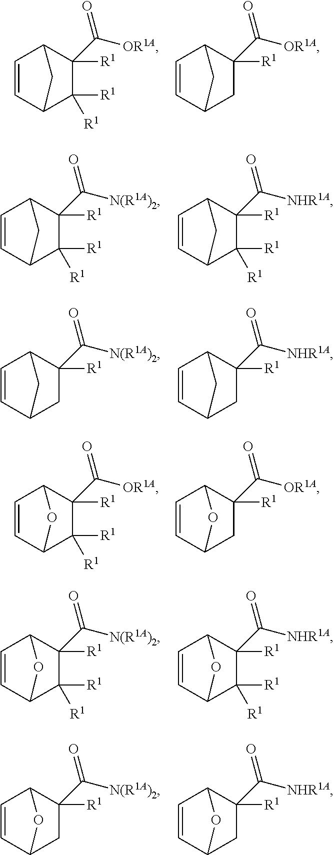

or a salt thereof.

In some embodiments, the ROMP precursor is a compound of:

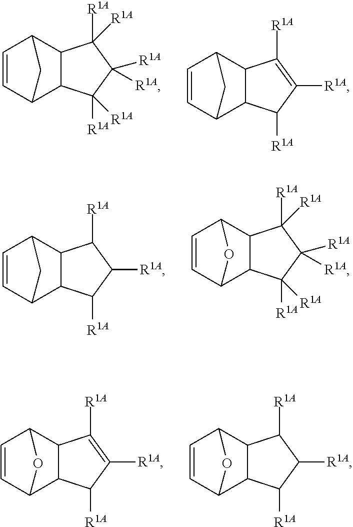

or a salt thereof.

In some embodiments, the ROMP precursor is a compound of:

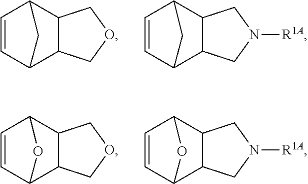

or a salt thereof.

In some embodiments, the ROMP precursor is a compound of:

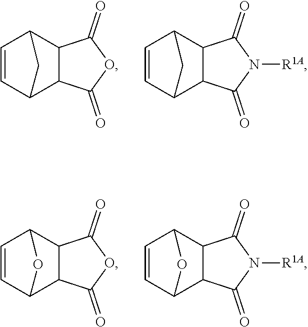

or a salt thereof.

In some embodiments, the ROMP precursor is a compound of:

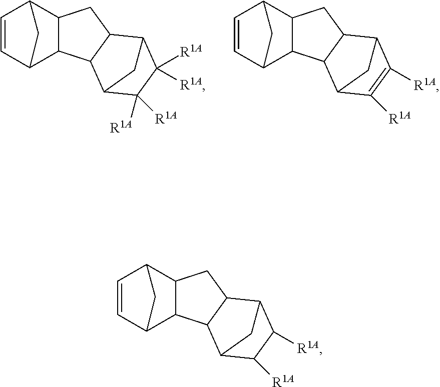

or a salt thereof.

In some embodiments, the ROMP precursor is a compound of:

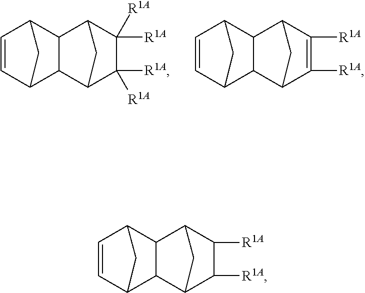

or a salt thereof.

In some embodiments, the ROMP precursor is a compound of:

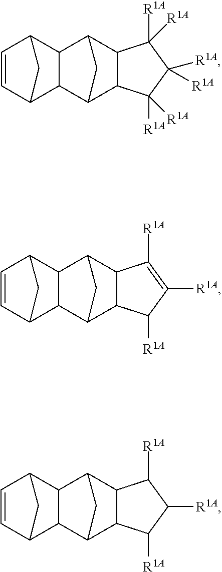

or a salt thereof.

In some embodiments, the ROMP precursor is a compound of:

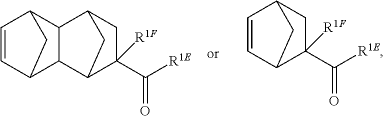

or a salt thereof, wherein R^{1F} is H, halogen, cyano, —OH, NH₂, C₁-C₂₀ alkyl, C₂-C₂₀ alkenyl, C₂-C₂₀ alkynyl, and wherein R^{1E} is

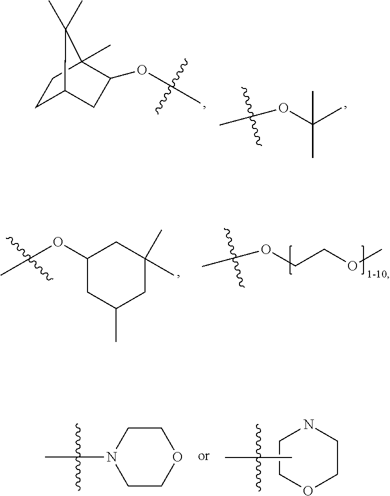

In some embodiments, the ROMP precursor is a compound of:

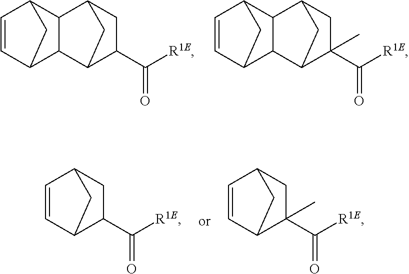

or a salt thereof, wherein R^{1E} is as defined herein.

In some embodiments, the ROMP precursor is a compound of:

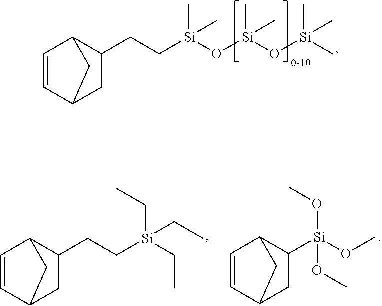

In some embodiments, the ROMP precursor is selected from the compounds described in Table 1 and salts thereof.

TABLE 1

| Compound No. | Structure/Name |
|---|---|
| 1 | 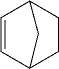 |
| 2 | 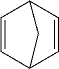 |
| 3 | 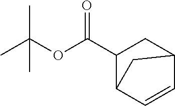 |
| 4 | 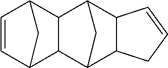 [SMILES: C1=CC2C(C1)C1CC2C2C3C=CC(C3)C12] |
| 5 | 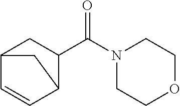 [SMILES: O=C(C1CC2C=CC1C2)N1CCOCC1] |
| 6 | 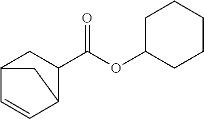 [SMILES: O=C(OC1CCCCC1)C1CC2C=CC1C2] |
| 7 | 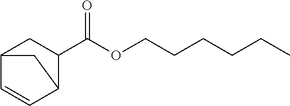 [SMILES: CCCCCCOC(=O)C1CC2C=CC1C2] |
| 8 | 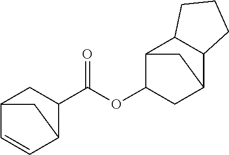 [SMILES: O=C(OC1CC2CC1C1CCCC21)C1CC2C=CC1C2] |
| 9 | 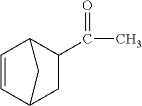 |
| 10 | 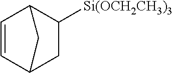 |
| 11 | 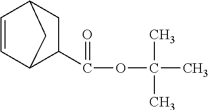 |
| 12 | 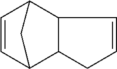 |
| 13 | 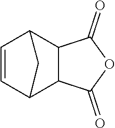 [SMILES: O=C1OC(=O)C2C3C=CC(C3)C12] |
| 14 | 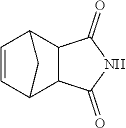 [SMILES: O=C1NC(=O)C2C3C=CC(C3)C12] |
| 15 | 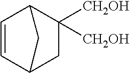 [SMILES: OCC1(CO)CC2C=CC1C2] |
| 16 | 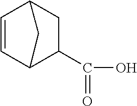 |
| 17 | 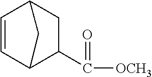 [SMILES: COC(=O)C1CC2C=CC1C2] |
| 18 | 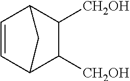 [SMILES: OCC1C2C=CC(C2)C1CO] |
| 19 | 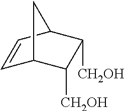 [SMILES: OCC1C2C=CC(C2)C1CO] |
| 20 | 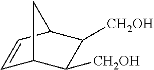 [SMILES: OCC1C2C=CC(C2)C1CO] |
| 21 | 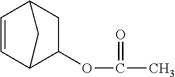 |
| 22 | 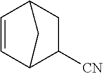 |
| 23 | 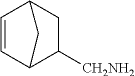 |
| 24 | 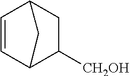 |
| 25 | 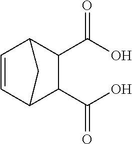 [SMILES: O=C(O)C1C2C=CC(C2)C1C(=O)O] |
| 26 | 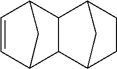 [SMILES: C1=CC2CC1C1C3CCC(C3)C21] |
| 27 | 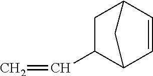 |
| 28 | 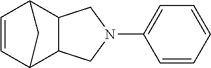 [SMILES: C1=CC2CC1C1CN(c3ccccc3)CC21] |
| 29 | 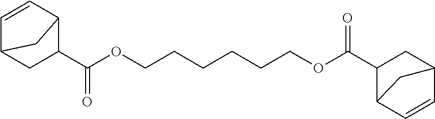 [SMILES: O=C(OCCCCCCOC(=O)C1CC2C=CC1C2)C1CC2C=CC1C2] |
| 30 | 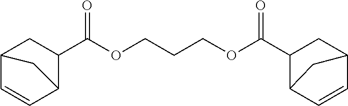 [SMILES: O=C(OCCCOC(=O)C1CC2C=CC1C2)C1CC2C=CC1C2] |
| 31 | 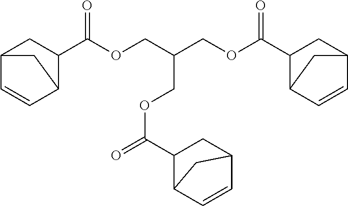 [SMILES: O=C(OCC(COC(=O)C1CC2C=CC1C2)COC(=O)C1CC2C=CC1C2)C1CC2C=CC1C2] |
| 32 | 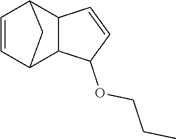 |
| 33 | 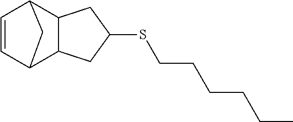 [SMILES: CCCCCCSC1CC2C3C=CC(C3)C2C1] |
| 34 | 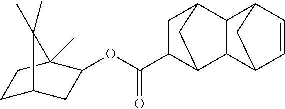 [SMILES: CC1(C)C2CCC1(C)C(OC(=O)C1CC3CC1C1C4C=CC(C4)C31)C2] |
| 35 | 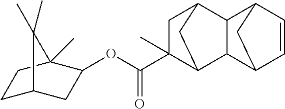 [SMILES: CC1(C(=O)OC2CC3CCC2(C)C3(C)C)CC2CC1C1C3C=CC(C3)C21] |
| 36 | 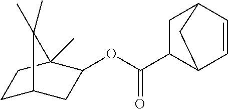 [SMILES: CC1(C)C2CCC1(C)C(OC(=O)C1CC3C=CC1C3)C2] |
| 37 | 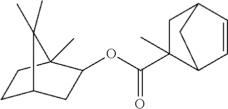 [SMILES: CC1(C(=O)OC2CC3CCC2(C)C3(C)C)CC2C=CC1C2] |
| 38 | 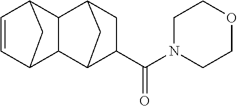 [SMILES: O=C(C1CC2CC1C1C3C=CC(C3)C21)N1CCOCC1] |
| 39 | 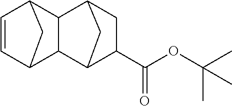 [SMILES: CC(C)(C)OC(=O)C1CC2CC1C1C3C=CC(C3)C21] |
| 40 | 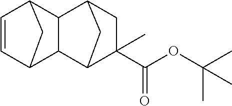 [SMILES: CC(C)(C)OC(=O)C1(C)CC2CC1C1C3C=CC(C3)C21] |
| 41 | 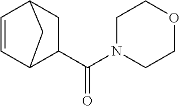 [SMILES: O=C(C1CC2C=CC1C2)N1CCOCC1] |
| 42 | 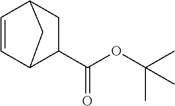 |
| 43 | 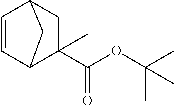 |
| 44 | 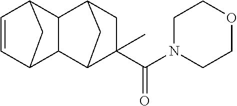 [SMILES: CC1(C(=O)N2CCOCC2)CC2CC1C1C3C=CC(C3)C21] |
| 45 | 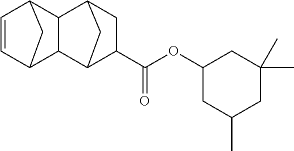 [SMILES: CC1CC(OC(=O)C2CC3CC2C2C4C=CC(C4)C32)CC(C)(C)C1] |
| 46 | 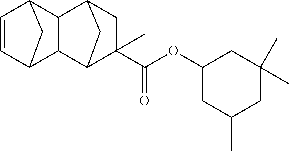 [SMILES: CC1CC(OC(=O)C2(C)CC3CC2C2C4C=CC(C4)C32)CC(C)(C)C1] |
| 47 | 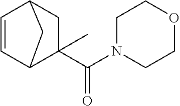 [SMILES: CC1(C(=O)N2CCOCC2)CC2C=CC1C2] |
| 48 | 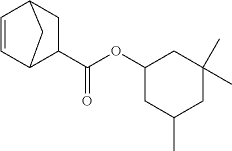 [SMILES: CC1CC(OC(=O)C2CC3C=CC2C3)CC(C)(C)C1] |
| 49 | 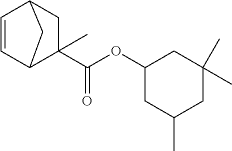 [SMILES: CC1CC(OC(=O)C2(C)CC3C=CC2C3)CC(C)(C)C1] |
| 50a | 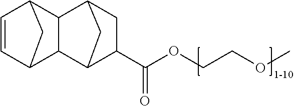 |
| 60a | 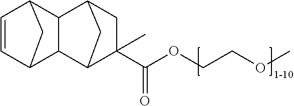 |
| 70a | 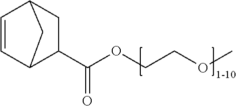 |
| 80a | 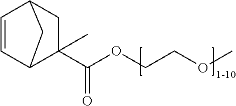 |

In some embodiments, the ROMP precursor is not dicyclopentadiene (DCPD).

In some embodiments, the ROMP precursor is present in the combination, build material, or kit disclosed herein as a neat liquid. In some embodiments, the ROMP precursor is compound 26 and the compound 26 is present in the combination, build material, or kit disclosed herein as a neat liquid.

As used herein, the term “neat liquid” refers to the use of a liquid component without the inclusion of an additional solvent.

### Curing Catalysts

In some embodiments, the disclosure provides a means for curing a composition disclosed herein. In some embodiments, the disclosure provides a means for catalyzing ROMP. In some embodiments, the disclosure provides a curing catalyst. In a preferred embodiment, the curing catalyst is a latent catalyst.

In some embodiments, the latent catalyst is a thermally latent catalyst, a photo-latent catalyst, or a chemically latent catalyst.

In some embodiments, the curing catalyst is activated by irradiation.

In some embodiments, the curing catalyst is activated by UV.

In some embodiments, the curing catalyst is activated by elevated temperature.

In some embodiments, the curing catalyst is activated by an activator.

In some embodiments, the curing catalyst is a Ruthenium catalyst.

In some embodiments, the curing catalyst is a Grubbs catalyst.

In some embodiments, the curing catalyst is first-generation Grubbs catalyst, second-generation Grubbs catalyst, or third-generation Grubbs catalyst.

In some embodiments, the latent Ru complex is a Grubbs-type catalyst. In some embodiments, the Grubbs-type catalyst comprises at least one N-heterocyclic carbene (NHC) or cyclic (alkyl)(amino)carbene (CAAC) ligand. In some embodiments, the Ru complex comprises a 16-electron species.

The activated Ru complex may comprise at least one N-heterocyclic carbene (NHC) or cyclic (alkyl)(amino)carbene (CAAC) ligand. The activated Ru complex may comprise one N-heterocyclic carbene (NHC) or cyclic (alkyl)(amino)carbene (CAAC) ligand. The activated Ru complex may comprise a 14-electron species.

In some embodiments, the curing catalyst is a compound described in U.S. Patent Appl'n Pub. Nos. 2020/0183276 and/or US20210163676A1 (incorporated herein by reference).

In some embodiments, the curing catalyst is Catalyst 1:

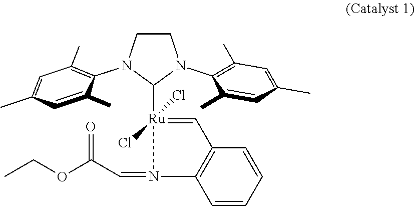

(1,3-dimesitylimidazolidin-2-ylidene)dichloro(2-((2-ethoxy-2-oxoethylidene)amino) benzylidene)ruthenium(II)), an isomer thereof, or a salt thereof. In some embodiments, the curing catalyst is Catalyst 1. In a further embodiment, Catalyst 1 is commercially available from Apeiron Synthesis under the name HeatMet.

In some embodiments, the curing catalyst is Catalyst 2:

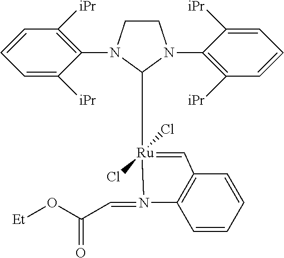

(dichloro(1,3-di-1-propylphenylimidazolidin-2-ylidene){2-[(ethoxy-2-oxoethylidene)amino]benzylidene} ruthenium(II)), an isomer thereof, or a salt thereof. In some embodiments, the curing catalyst is Catalyst 2. In a further embodiment, Catalyst 2 is commercially available from Apeiron Synthesis under the name HeatMet SIPr.

In some embodiments, the curing catalyst is a catalyst described in U.S. Pat. No. 9,610,572, the contents of which are incorporated herein by reference in its entirety for all purposes.

In some embodiments, the curing catalyst is a compound of formula (C-I):

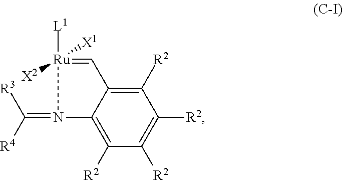

wherein
L¹ is

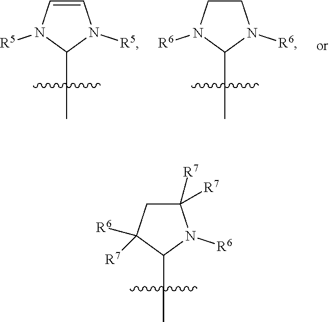

X¹ is halogen, C₁₋₂₄alkoxy, or thiolate;
X² is absent, halogen, C₁₋₂₄alkoxy, or thiolate;
each R² is independently hydrogen, halogen, OH, C₁₋₂₄alkyl, C₁₋₂₄alkoxy, C₁₋₂₄ fluoroalkyl, C₁₋₂₄fluoroalkoxy, C₁₋₂₄alkylhydroxy, C₁₋₂₄alkoxyhydroxy, C₁₋₂₄fluoroalkylhydroxy, C₁₋₂₄fluoroalkoxyhydroxy, C₃-C₂₀ cycloalkyl, C₆-C₂₀ aryl, 3- to 20-membered heterocycloalkyl, 5- to 20-membered heteroaryl, NO₂, NR⁸R⁹, OC(O)R¹⁰, C(O)OR¹⁰, NR¹¹C(O)R¹⁰, C(O)NR¹¹R¹⁰, cyano, nitro, silyl, or phosphonyl;
R³ is hydrogen, C₁₋₂₄alkyl, C₃-C₂₀ cycloalkyl, C₆-C₂₀ aryl, 3- to 20-membered heterocycloalkyl, 5- to 20-membered heteroaryl, OC(O)R¹², C(O)OR², NR¹³C(O)R¹², or C(O)NR¹²R¹³; and when X² is absent, then R³ is attached to Ru via an oxy moiety (e.g., —O—);
R⁴ is hydrogen, C₁₋₂₄alkyl, C₃-C₂₀ cycloalkyl, or C₆-C₂₀ aryl;
Each R⁵ is independently C₆-C₂₀ aryl wherein the aryl is optionally substituted by one or more R¹⁴;
each R⁶ is independently C₁₋₂₄alkyl or C₆-C₂₀ aryl, wherein the alkyl or aryl is optionally substituted by one or more R¹⁴;
each R⁷ is independently hydrogen or C₁₋₂₄alkyl wherein the alkyl is optionally substituted by one or more R¹⁴; or
the adjacent R⁶ and R⁷, together with the carbon atom to which they attach, form 3- to 20-membered heterocycloalkyl; and
each R⁸, R⁹, R¹⁰, R¹¹, R¹², R¹³ and R¹⁴ is independently hydrogen, C₁₋₂₄ alkyl, C₃-C₂₀ cycloalkyl, or C₆-C₂₀ aryl.

In some embodiments, X² is halogen, C₁₋₂₄ alkoxy, or thiolate.

In some embodiments, Each R⁶ is independently C₁₋₂₄ alkyl or C₆-C₂₀ aryl, wherein the alkyl or aryl is optionally substituted by one or more R¹⁴; and each R⁷ is independently hydrogen or C₁₋₂₄alkyl wherein the alkyl is optionally substituted by one or more R¹⁴.

In some embodiments, the curing catalyst is a compound of formula (C-II):

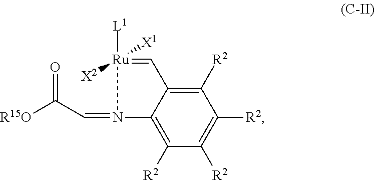

or a salt thereof, wherein L, X¹, X², and R² are as described herein, and R¹⁵ is hydrogen, C₁₋₂₄alkyl, C₃-C₂₀ cycloalkyl, C₆-C₂₀ aryl, 3- to 20-membered heterocycloalkyl, or 5- to 20-membered heteroaryl.

In some embodiments, the curing catalyst is selected from

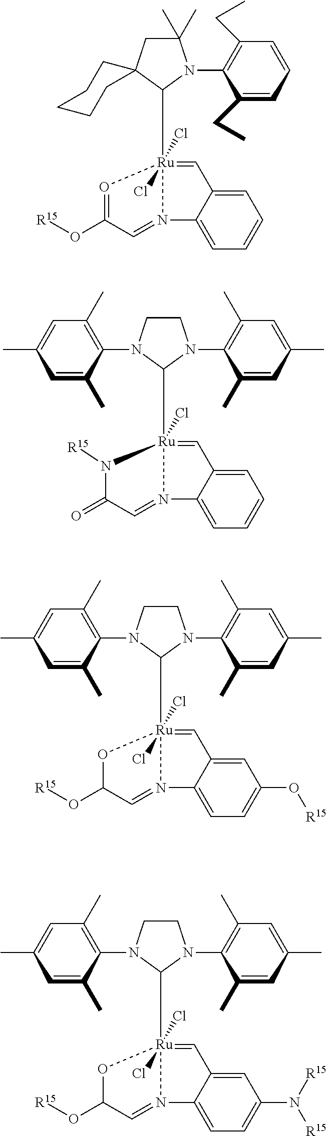

or a salt of any of the foregoing, wherein each R¹⁵ is independently C₁₋₂₄ alkyl or C₆-C₂₀ aryl.

In same embodiments, the curing catalyst is selected from

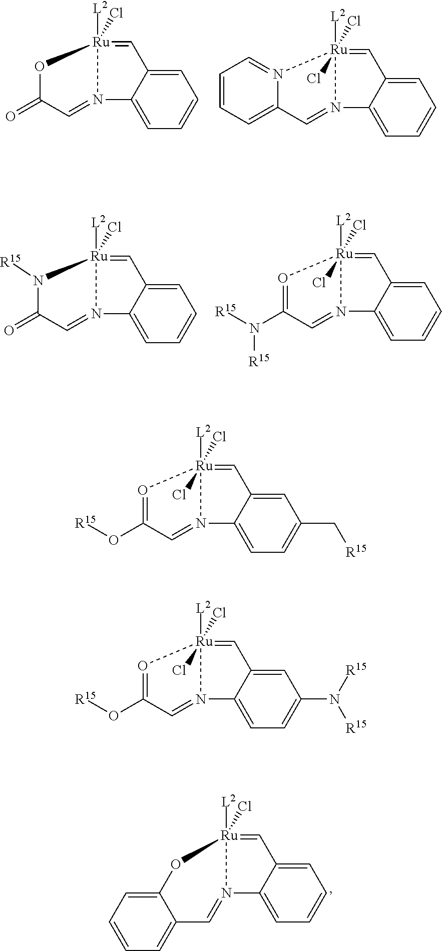

or a salt of any of the foregoing, R¹⁵ is as described herein and L² is selected from:

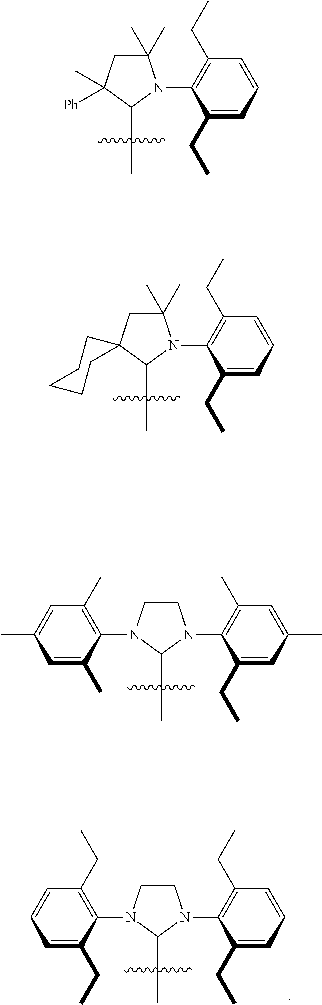

In some embodiments, the curing catalyst is a compound described in U.S. Patent Appl'n Pub. No. 2020/0002466 (incorporated herein by reference).

In some embodiments, the curing catalyst is a compound of:

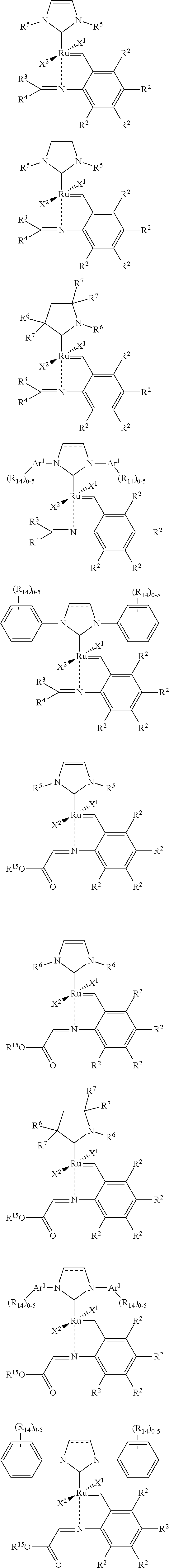

wherein L¹, X¹, X², R², R³, R⁴, R⁵, R⁶, R⁷, and R¹⁴ are as described herein, and wherein each A¹ is independently C₆-C₂₀ aryl.

It is understood that, for a compound of Formula (C-I) or (C-II), X¹, X², R², R³, R⁴, R⁵, R⁶, R⁷, R⁸, R⁹, R¹⁰, R¹¹, R¹², R¹³, R¹⁴, L¹, and A¹ can each be, where applicable, selected from the groups described herein, and any group described herein for any of X¹, X², R², R³, R⁴, R⁵, R⁶, R⁷, R⁸, R⁹, R¹⁰, R¹¹, R¹², R¹³, R¹⁴, L¹, and A¹ can be combined, where applicable, with any group described herein for one or more of the remainder X¹, X², R², R³, R⁴, R⁵, R⁶, R⁷, R⁸, R⁹, R¹⁰, R¹¹, R¹², R¹³, R¹⁴, L¹, and A¹.

In some embodiments, the curing catalyst is selected from Catalyst 1, Catalyst 2, or

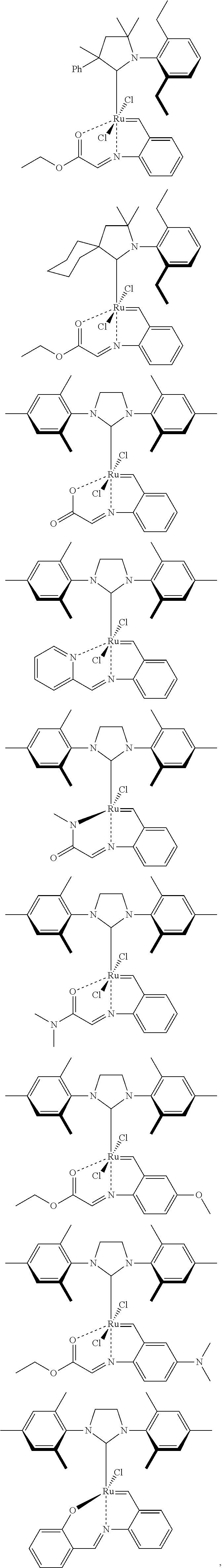

Or a salt of any of the foregoing.

In some embodiments, the curing catalyst is present in the combination, build material, or kit disclosed herein in a concentration of between about 1 and about 1000 mol/mol parts per million (“ppm”), between about 1 and about 500 ppm mol/mol, between about 1 and about 400 ppm mol/mol, between about 1 and about 300 ppm mol/mol, between about 1 and about 200 ppm mol/mol, between about 50 and about 150 ppm mol/mol, between about 75 and about 125 ppm mol/mol, between about 90 and about 110 ppm mol/mol or about 100 ppm mol/mol.

In some embodiments, the curing catalyst is Catalyst 1 and the Catalyst 1 is present in the combination, build material, or kit disclosed herein in a concentration of between about 1 and about 1000 ppm mol/mol, between about 1 and about 500 ppm mol/mol, between about 1 and about 400 ppm mol/mol, between about 1 and about 300 ppm mol/mol, between about 1 and about 200 ppm mol/mol, between about 50 and about 150 ppm mol/mol, between about 75 and about 125 ppm mol/mol, between about 90 and about 110 ppm mol/mol, or about 100 ppm mol/mol.

### Free Radical Initiators

In some embodiments, the disclosure provides means for initiating a ring-opening metathesis reaction. In some embodiments, the disclosure provides means for activating a curing catalyst as disclosed herein. In some embodiments, the disclosure provides means for generating a free radical.

In some embodiments, the disclosure provides means for initiating a ring-opening metathesis reaction without generating a substantial amount of a strong acid. In some embodiments, the disclosure provides means for activating a curing catalyst as disclosed herein without generating a substantial amount of a strong acid. In some embodiments, the disclosure provides means for generating a free radical without generating a substantial amount of a strong acid.

In some embodiments, the disclosure provides means for initiating a ring-opening metathesis reaction without generating a substantial amount of a strong oxidizing agent. In some embodiments, the disclosure provides means for activating a curing catalyst as disclosed herein without generating a substantial amount of a strong oxidizing agent. In some embodiments, the disclosure provides means for generating a free radical without generating a substantial amount of a strong oxidizing agent.

In some embodiments, the disclosure provides means for initiating a ring-opening metathesis reaction without generating a substantial amount of a strong reducing agent. In some embodiments, the disclosure provides means for activating a curing catalyst as disclosed herein without generating a substantial amount of a strong reducing agent. In some embodiments, the disclosure provides means for generating a free radical without generating a substantial amount of a strong reducing agent.

In some embodiments, the disclosure provides a free radical initiator. The terms “free radical initiator,” and “radical initiator,” as used herein, are used interchangeably and refer to a compound that produces radical species and promotes radical reactions.

In some embodiments, the free radical initiator is an acid-independent free radical initiator. As used herein, the term “acid-independent free radical initiator” refers to a free radical initiator wherein the generation of radical species is not associated with the generation of a substantial amount of strong acid species. A skilled artisan will recognize that an acid-independent free radical initiator, as described herein, can be distinguished from, e.g., a photoacid generator. In some embodiments, a “substantial amount of strong acid” refers to a molar ratio of strong acid species generated to radical species generated of less than about 75%, less than about 50%, less than about 45%, less than about 40%, less than about 35%, less than about 30%, less than about 25%, less than about 20%, less than about 15%, less than about 10%, less than about 5%, or less than about 1%. In some embodiments, a “substantial amount of strong acid” refers to any detectible amount of strong acid as determined by routine methods known in the art.

As used herein, the term “strong acid” refers to an acid having a pKa of less than about 0 in water or DMSO.

As used herein, a “photoacid generator” (PAG) refers to a compound capable of generating a strong acid upon exposure to electromagnetic radiation. A PAG may be any compound capable of generating an acid upon exposure to high-energy radiation. In some embodiments, those compounds capable of generating sulfonic acid, hydrogen tetrafluoroborate, hydrogen hexafluorophosphate, hydrogen hexafluoroantimonate, hydrogen tetrakis(pentafluorophenyl)borate, and hydrogen tetrakis[3,5-bis(trifluoromethyl)phenyl]borate, hydrochloric acid, hydrobromic acid, hydoiodic acid, or perchloric acid may be used. Suitable PAGs include sulfonium salts, iodonium salts, sulfonyldiazomethane, N-sulfonyloxyimide, and oxime-O-sulfonate acid generators. Exemplary PAGs are described in, e.g., U.S. Pat. No. 7,537,880 and U.S. application Ser. No. 17/070,557.

In some embodiments, the free radical initiator is a redox-independent free radical initiator. As used herein, the term “redox-independent free radical initiator” refers to a free radical initiator wherein the generation of radical species is not associated with the generation of a substantial amount of a strong oxidizing or reducing agent. In some embodiments, a “substantial amount of a strong oxidizing or reducing agent” refers to a molar ratio of strong oxidizing or reducing agent species generated to radical species generated of less than about 75%, less than about 50%, less than about 45%, less than about 40%, less than about 35%, less than about 30%, less than about 25%, less than about 20%, less than about 15%, less than about 10%, less than about 5%, or less than about 1%. In some embodiments, a “substantial amount of an oxidizing or reducing agent” refers to any detectible amount of strong oxidizing or reducing agent as determined by routine methods known in the art.

In some embodiments, the free radical initiator is a photoinitiator, a thermal initiator, a chemical initiator, or an acoustic initiator. In some embodiments, the free radical initiator is an acid-independent free radical photoinitiator, an acid-independent free radical thermal initiator, an acid-independent free radical chemical initiator, or an acid-independent free radical acoustic initiator. In some embodiments, the free radical initiator is an acid-independent free radical photoinitiator, a redox-independent free radical thermal initiator, a redox-independent free radical chemical initiator, or a redox-independent free radical acoustic initiator.

As used herein, the term “strong oxidizing agent” is a compound having an excited or ground state reduction potential (volts v. saturated calomel electrode) of greater than 1.5 as measured by routine methods known in the art. As used herein, the term “strong reducing agent” is a compound having an excited or ground state reduction potential (volts v. saturated calomel electrode) of less than (i.e., more negative) than −1.5 as measured by routine methods known in the art.

In some embodiments, the free radical initiator is a both an acid-independent free radical initiator and a redox-independent free radical initiator.

### Photoinitialors

The free radical initiator may be a free radical photoinitiator, more specifically a Norrish type I initiator or a Norrish type II initiator. A free radical photoinitiator is a chemical compound that initiates polymerization of monomers and oligomers when exposed to electromagnetic (e.g., UV and visible) radiation by the formation of a free radical. A Norrish Type I initiator is an initiator which cleaves after excitation, yielding the initiating radical immediately. A Norrish type II-initiator is a photoinitiator which is activated by electromagnetic (e.g., UV and visible) radiation and forms free radicals by hydrogen abstraction. This hydrogen abstraction commonly occurs from a second compound called a polymerization synergist or co-initiator. Both type I and type II photoinitiators can be used in the described methods and compositions, alone or in combination.

Examples of suitable Norrish Type I photoinitiators are benzoin derivatives, methylolbenzoin and 4-benzoyl-1,3-dioxolane derivatives, benzilketals, α,α-dialkoxyacetophenones, hydroxyacetophenones, aminoacetophenones α-hydroxy alkylphenones, α-aminoalkylphenones, acylphosphine oxides, bisacylphosphine oxides, acylphosphine sulphides, halogenated acetophenone derivatives, and the like. Commercial examples of suitable Norrish Type I photoinitiators are 2-hydroxy-4′-(2-hydroxyethoxy)-2-methyl propiophenone (e.g., as sold under the name IRGACURE® 2959), benzildimethyl ketal or 2,2-dimethoxy-1,2-diphenylethanone (e.g., as sold under the name IRGACURE® 651 from Ciba-Geigy), 1-hydroxy-cyclohexyl-phenyl ketone (e.g., as sold under the name IRGACURE® 184 from Ciba-Geigy), 2-hydroxy-2-methyl-1-phenylpropan-1-one (e.g., as sold under the name Darocur 1173 from Ciba-Geigy), 2-methyl-1-[4-(methylthio)phenyl]-2-morpholino propan-1-one (e.g., as sold under the name IRGACURE® 907 from Ciba-Geigy), 2-benzyl-2-dimethylamino-1-(4-morpholinophenyl)-butan-1-one (e.g., as sold under the name IRGACURE® 369 from Ciba-Geigy), poly {2-hydroxy-2-methyl-1-[4-(1-methylvinyl)phenyl]propan-1-one}, (e.g., as sold under the name Esacure KIP 150 from Fratelli Lamberti), a blend of poly {2-hydroxy-2-methyl-1-[4-(1-methylvinyl)phenyl]propan-1-one} and 2-hydroxy-2-methyl-1-phenyl-propan-1-one (e.g., as sold under the name Esacure KIP 100 F from Fratelli Lamberti), a blend of poly {2-hydroxy-2-methyl-1-[4-(1-methylvinyl)phenyl]propan-1-one}, 2,4,6-trimethylbenzoyldiphenyl-phosphine oxide and methylbenzophenone derivatives (e.g., as sold under the name Esacure KTO 46 from Fratelli Lamberti), acylphosphine oxides such as 2,4,6-trimethylbenzoyl diphenyl phosphine oxide (e.g., as sold under the name Lucirin TPO from BASF), bis(2,4,6-trimethylbenzoyl)-phenyl-phosphine-oxide (e.g., as sold under the name IRGACURE® 819 from Ciba-Geigy), a 25:75% blend of bis(2,6-dimethoxybenzoyl)2,4,4-trimethyl-pentyl phosphine oxide and 2-hydroxy-2-methyl-1-phenyl-propan-1-one (e.g., as sold under the name IRGACURE® 1700 from Ciba-Geigy), phenyl bis(2,4,6-trimethylbenzoyl)-phosphine oxide (e.g., as sold under the name SpeedCure BPO), ethyl (2,4,6-trimethylbenzoyl) phenyl phosphinate (e.g., as sold under the name SpeedCure TPO-L) and the like. Also, mixtures of type I photoinitiators can be used.

Examples of Norrish Type H photoinitiators include aromatic ketones such as benzophenone, xanthone, derivatives of benzophenone (e.g., chlorobenzophenone), blends of benzophenone and benzophenone derivatives (e.g., a 50/50 blend of 4-methyl-benzophenone and benzophenone as sold under the name Photocure 81), benzyl formates, Michler's Ketone, Ethyl Michler's Ketone, thioxanthone and other xanthone derivatives, isopropyl thioxanthone, 2-isopropyl thioxanthone (e.g., as sold under the name Quantacure ITX), 4-isopropyl thioxanthone, 2,4-diethylthioxanthone (e.g., as sold under the name SpeedCure DETX), 1-chloro-4-propoxythioxanthone (e.g., as sold under the name SpeedCure CPTX), benzil, anthraquinones (e.g., 2-ethyl anthraquinone), coumarin, or chemical derivatives or combinations of these photoinitiators. In some embodiments, the Norrish Type II photoinitiator is selected from: ITX, DETX, CPTX, ethyl Michler's ketone, and Michler's ketone.

In some embodiments, the photoinitiator is ethyl (2,4,6-trimethylbenzoyl) phenyl phosphinate (TPO-L).

In some embodiments, the photoinitiator is not isopropyl thioxanthone (ITX). In some embodiments, the photoinitiator is not 2-isopropyl thioxanthone. In some embodiments, the photoinitiator is not 4-isopropyl thioxanthone. In some embodiments, the photoinitiator is not camphorquinone. In some embodiments, the photoinitiator is not benzil.

In some embodiments, the photoinitiator is present in the combination, build material, or kit disclosed herein in a concentration of between about 1 and about 10,000 ppm mol/mol, between about 100 and about 10,000 ppm mol/mol, between about 100 and about 6,000 ppm mol/mol, between about 100 and about 5,000 ppm mol/mol, between about 500 and about 5,000 ppm mol/mol, between about 500 and about 4,000 ppm mol/mol, between about 500 and about 3,000 ppm mol/mol, between about 1,000 and about 3,000 ppm mol/mol, between about 1,500 and about 2,500 ppm mol/mol, or about 2,000 ppm mol/mol.

In some embodiments, the photoinitiator is 2-isopropyl thioxanthone and the 2-isopropyl thioxanthone is present in the combination, build material, or kit disclosed herein in a concentration of between about 1 and about 10,000 ppm mol/mol, between about 100 and about 10,000 ppm mol/mol, between about 100 and about 6,000 ppm mol/mol, between about 100 and about 5,000 ppm mol/mol, between about 500 and about 5,000 ppm mol/mol, between about 500 and about 4,000 ppm mol/mol, between about 500 and about 3,000 ppm mol/mol, between about 1,000 and about 3,000 ppm mol/mol, between about 1,500 and about 2,500 ppm mol/mol, or about 2,000 ppm mol/mol.

### Thermal, Chemical, and Acoustic Initiators

Thermal initiators useful in the present invention include, but are not limited to azo, organic peroxide, and persulfate (i.e., peroxydisulfate) free radical initiators. Thermal initiators may also function as chemical and acoustic initiators and/or chemical initiators.

Suitable azo initiators include, but are not limited to 2,2′-azobis(4-methoxy-2,4-dimethylvaleronitrile); 2,2′-azobis(2-amidinopropane) dihydrochloride; 2,2′-azobis(2,4-dimethylvaleronitrile); dimethyl 2,2′-azobis(2-methylpropionate); 2,2′-azobis[2-methyl-N-(2-hydroxyethyl)propionamide; 2,2′-azobis(isobutyronitrile); 2,2′-azobis-2-methylbutyronitrile;1,1′-azobis(1-cyclohexanecarbonitrile); and 2,2′-azobis(methyl isobutyrate).

Suitable organic peroxide initiators include, but are not limited to, alkyl peroxybenzoates (e.g., tert-amyl peroxybenzoate), benzoyl peroxide, methyl ethyl ketone peroxide, acetyl peroxide, lauroyl peroxide, decanoyl peroxide, dicetyl peroxydicarbonate, di(4-t-butylcyclohexyl) peroxydicarbonate, di(2-ethylhexyl)peroxydicarbonate, t-butylperoxypivalate, t-butyl peroxy-2-ethylhexanoate, and dicumyl peroxide.

Suitable persulfate (i.e., peroxydisulfate) initiators include, but are not limited to, potassium persulfate, sodium persulfate, and ammonium persulfate.

### Synergists

In order to increase the photosensitivity further, the composition may additionally contain synergists (or co-initiators). Suitable examples of co-initiators can be categorized in three groups: 1) tertiary aliphatic amines such as methyldiethanolamine, dimethylethanolamine, triethanolamine, triethylamine and N-methylmorpholine; (2) aromatic amines such as amylparadimethyl-aminobenzoate, 2-n-butoxyethyl-4-(dimethylamino) benzoate, 2-(dimethylamino)-ethyl benzoate, ethyl-4-(dimethylamino)benzoate, and 2-ethylhexyl-4-(dimethylamino)benzoate; and (3) (meth)acrylated amines such as dialkylamino alkyl(meth)acrylates (e.g., diethylaminoethylacrylate) or N-morpholinoalkyl-(meth)acrylates (e.g., N-morpholinoethyl-acrylate).

In some embodiments, the synergist is not ethyl 4-dimethylaminobenzoate (EDAB).

In some embodiments, the molar ratio between the initiator and the curing catalyst is between about 1:1 and about 100:1, between about 1:1 and about 50:1, or between about 1:1 and about 10:1.

In some embodiments, the synergist is present in the combination, build material, or kit disclosed herein in a concentration of between about 1 and about 10,000 ppm mol/mol, between about 100 and about 10,000 ppm mol/mol, between about 100 and about 6,000 ppm mol/mol, between about 100 and about 5,000 ppm mol/mol, between about 500 and about 5,000 ppm mol/mol, between about 500 and about 4,000 ppm mol/mol, between about 500 and about 3,000 ppm mol/mol, between about 1,000 and about 3,000 ppm mol/mol, between about 1,500 and about 2,500 ppm mol/mol, or about 2,000 ppm mol/mol.

In some embodiments, the synergist is ethyl-4-(dimethylamino)benzoate and the ethyl-4-(dimethylamino)benzoate is present in the combination, build material, or kit disclosed herein in a concentration of between about 1 and about 10,000 ppm mol/mol, between about 100 and about 10,000 ppm mol/mol, between about 100 and about 6,000 ppm mol/mol, between about 100 and about 5,000 ppm mol/mol, between about 500 and about 5,000 ppm mol/mol, between about 500 and about 4,000 ppm mol/mol, between about 500 and about 3,000 ppm mol/mol, between about 1,000 and about 3,000 ppm mol/mol, between about 1,500 and about 2,500 ppm mol/mol, or about 2,000 ppm mol/mol.

### Sensitizers

Although photosensitizers can be capable of generating high-energy species upon exposure to electromagnetic (e.g., UV and visible) radiation, they are useful primarily for their ability to increase the efficacy of photoinitiation of an associated photoinitiator(s), either by increasing the rate of photoinitiation or by shifting the wavelength at which polymerization occurs. The term “photosensitizer” generally refers to any substance that increases the rate of photoinitiation, particularly by shifting the wavelength at which an associated photoinitiator is effective at inducing polymerization to occur; see textbook by G. Odian, Principles of Polymerization, 3rd Ed., 1991, page 222. Photosensitizers generally act by absorbing light in the ultraviolet or visible region of the electromagnetic spectrum, and then transferring energy to adjacent molecules.

A variety of compounds can be used as photosensitizers, including heterocyclic and fused-ring aromatic hydrocarbons, organic dyes, and aromatic ketones. Examples of photosensitizers include those selected from the group consisting of methanones, xanthenones, pyrenemethanols, anthracenes, pyrene, perylene, quinones, xanthones, thioxanthones, benzoyl esters, benzophenones, and any combination thereof. Particular examples of photosensitizers include those selected from the group consisting of [4-[(4-methylphenyl)thio]phenyl]phenyl-methanone, isopropyl-9H-thioxanthen-9-one, 1-pyrenemethanol, 9-(hydroxymethyl)anthracene, 9,10-diethoxyanthracene, 9,10-dimethoxyanthracene, 9,10-dipropoxyanthracene, 9,10-dibutyloxyanthracene, 9-anthracenemethanol acetate, 2-ethyl-9,10-dimethoxyanthracene, 2-methyl-9,10-dimethoxyanthracene, 2-t-butyl-9,10-dimethoxyanthracene, 2-ethyl-9,10-diethoxyanthracene and 2-methyl-9,10-diethoxyanthracene, anthracene, anthraquinones, 2-methylanthraquinone, 2-ethylanthraquinone, 2-tertbutylanthraquinone, 1-chloroanthraquinone, 2-amylanthraquinone, thioxanthones and xanthones, isopropyl thioxanthone, 2-chlorothioxanthone, 2,4-diethylthioxanthone, 1-chloro-4-propoxythioxanthone, methyl benzoyl formate (e.g., as sold under the name Darocur MBF from BASF), methyl-2-benzoyl benzoate (e.g., as sold under the name CHIVACURE® OMB from Chitec), 4-benzoyl-4′-methyl diphenyl sulfide (e.g., as sold under the name CHIVACURE® BMS from Chitec), 4,4′-bis(diethylamino) benzophenone (e.g., as sold under the name CHIVACURE® EMK from Chitec), and any combination thereof.

### Radical Polarity Reversal Catalysts

In some embodiments, the combination or build material further comprises a radical polarity reversal catalyst. Without wishing to be bound by theory, it may be advantageous to replace a single-step abstraction, that is slow because of unfavorable polar effects, with a two-step process in which the radicals and substrates are polarity-matched. See, e.g., Roberts, B. P. Polarity-Reversal Catalysis of Hydrogen-Atom Abstraction Reactions: Concepts and Applications in Organic Chemistry. Chemical Society Reviews, 1999, 28, 25-35. Suitable radical polarity reversal catalysts include, but are not limited to, thiols (e.g., n-alkyl thiols and thiophenols) and amine-boranes (e.g., dimethylamine-borane and trimethylamine-borane).

### Antioxidants

In some embodiments, the combination or build material further comprises an antioxidant. Antioxidants may be classified as primary or secondary antioxidants depending on the method by which they prevent oxidation. Without wishing to be bound by theory, primary antioxidants may function by donating their reactive hydrogen to the peroxy free radical so that the propagation of subsequent free radicals does not occur. The antioxidant free radical is rendered stable by electron delocalization. Secondary antioxidants may retard oxidation by preventing the proliferation of alkoxy and hydroxyl radicals by decomposing hydroperoxides to yield nonreactive products. These materials may be used in a synergistic combination with primary antioxidants.

Suitable antioxidants include, for example, organic phosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; benzene polyols, such as catechols or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants.

As used herein, the term “phenol” refers to compounds that comprise one or more hydroxyl groups directly bonded to a phenyl group. Examples of phenols include, e.g., butylated hydroxytoluene (BHT), 4-tert-butylcatechol, 1,8-dihvdroxynaphthalene, or the like.

As used herein, the term “monophenol” refers to compounds that comprise one hydroxyl group that is directly bonded to a phenyl group. Examples of monophenols include, e.g., butylated hydroxytoluene (BHT) or the like.

As used herein, the term “polyphenol” refers to compounds that comprise two or more hydroxyl groups that are directly bonded to a phenyl group. Examples of polyphenols include, e.g., 2,3-dihydroxynaphthalene, 1,8-dihydroxynaphthalene, or the like.

As used herein, the term “benzene polyol” refers to compounds that comprise at least one phenyl group that is directly bonded to two or more hydroxyl groups. Examples of benzene polyols include 2,3-dihydroxynaphthalene, 4-tert-butylcatechol, 3,5-di-tert-butylcatechol, octyl gallate, pyrocatechol, or the like. Benzene polyols may be alkylated (e.g., 4-tert-butylcatechol, 3,5-di-tert-butylcatechol, octyl gallate, or the like) or non-alkylated (e.g., 2,3-dihydroxynaphthalene, pyrocatechol, pyrogallol, or the like).

In some embodiments, the primary antioxidant is a hindered phenol, a secondary aryl amine, a benzene polyol (e.g., an alkylated benzene polyol or a non-alkylated benzene polyol), or a combination thereof. In some embodiments, the hindered phenol comprises one or more compounds selected from butylated hydroxytoluene (BHT), triethylene glycol bis[3-(3-t-butyl-5-methyl-4-hydroxyphenyl)propionate], 1,6-hexanediolbis[3-(3,5-di-t-butyl-4-hydroxyphenyl)propionate], 2,4-bis(n-octylthio)-6-(4-hydroxy-3,5-di-t-butylanilino)-1,3,5-triazine, pentaerythrityl tetrakis[3-(3,5-di-t-butyl-4-hydroxyphenyl)propionate], 2,2-thiodiethylene bis[3-(3,5-di-t-butyl-4-hydroxyphenyl)propionate], octadecyl 3-(3,5-di-t-butyl-4-hydroxyphenyl)propionate, N,N′-hexamethylene bis(3,5-di-t-butyl-4-hydroxy-hydrocinnamamide), tetrakis(methylene 3,5-di-tert-butyl-hydroxycinnamate)methane, and octadecyl 3,5-di-tert-butylhydroxyhydrocinnamate.

In some embodiments, the benzene polyol comprises a phenyl group that is directly substituted with two or more alcohol groups. In some embodiments, the benzene polyol may comprise a dihydroxybenzene or a trihydroxybenzene. In some embodiments, the dihydroxybenzene may comprise a catechol, a resorcinol, or a hydroquinone. In some embodiments, the trihydroxybenzene may comprise a pyrogallol, a hydroxyquinol, or a phloroglucinol. In some embodiments, the benzene polyol may comprise a compound of Formula (A-I):

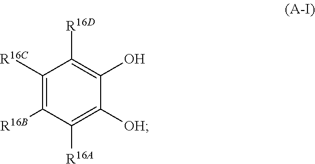

or a salt thereof, wherein:
each of R^{16A}, R^{16B}, R^{16C}, and R^{16D} is independently H, a halogen, cyano, —OR¹⁷, —SR¹⁷, —C(═O)—R¹⁷, —C(═O)—OR¹⁷, —O—C(═O)—R¹⁷, —C(═O)—N(R¹⁷)₂, —C(═O)—NHR¹⁷, —NH—C(═O)—R¹⁷, —N(R¹⁷)₂, —Si(R¹⁷)₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R¹⁷; and
each R¹⁷ is independently H, a halogen, cyano, —OH, —NH₂, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl.

In some embodiments, at least one of R^{16A}, R^{16B}, R^{16C}, and R^{16D} is H.

In some embodiments, at least two of R^{16A}, R^{16B}, R^{16C}, and R^{16D} are H.

In some embodiments, at least three of R^{16A}, R^{16B}, R^{16C}, and R^{16D} are H.

In some embodiments, at least one of R^{16A}, R^{16B}, R^{16C}, and R^{16D} is a halogen, cyano, —OR¹⁷, —SR¹⁷, —C(═O)—R¹⁷, —C(═O)—OR¹⁷, —O—C(═O)—R¹⁷, —C(═O)—N(R¹⁷)₂, —C(═O)—NHR¹⁷, —NH—C(═O)—R¹⁷, —N(R¹⁷)₂, —Si(R¹⁷)₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R¹⁷.

In some embodiments, at least one of R^{16A}, R^{16B}, R^{16C}, and R^{16D} is a C₁-C₂₀ alkyl.

In some embodiments, at least one of R^{16A}, R^{16B}, R^{16C}, and R^{16D} is a C₂-C₂₀ alkenyl.

In some embodiments, at least one of R^{16A}, R^{16B}, R^{16C}, and R^{16D} is a C₂-C₂₀ alkynyl.

In some embodiments, at least one of R^{16A}, R^{16B}, R^{16C}, and R^{16D} is a C₃-C₂₀ cycloalkyl.

In some embodiments, at least one of R^{16A}, R^{16B}, R^{1C}, and R^{16D} is a 3- to 20-membered heterocycloalkyl.

In some embodiments, at least one of R^{16A}, R^{16B}, R^{16C}, and R^{16D} is —OR¹⁷.

In some embodiments at least one of R^{16A}, R^{16B}, R^{16C}, and R^{16D} is OR¹⁷ and R¹⁷ is H.

In some embodiments, the compound of Formula (A-I) may be a catechol. In some embodiments, the catechol is 4-tert-butylcatechol or 3,5-di-tert-butylcatechol. In some embodiments, the catechol is 4-tert-butylcatechol. In some embodiments, the catechol is 3,5-di-tert-butylcatechol.

In some embodiments, the compound of Formula (A-I) may be a trihydroxybenzene. In some embodiments, the trihydroxybenzene is octyl gallate.

In some embodiments the secondary antioxidant is selected from an organophosphite, thioether and thioester, or a combination thereof. In some embodiments, the secondary antioxidant comprises one or more compounds selected from tetrakis(2,4-di-tert-butylphenyl)phosphite, tributylphosphite, triisodecylphosphite, triphenylphosphite, [1,1-biphenyl]-4,4′-diylbisphosphonite, tris(2,4-di-tert-butylphenyl)phosphite, bis(2,4-di-tert-butylphenyl)pentaerythritol diphosphite, bis(2,4-dicumylphenyl)pentaerytritoldiphosphite, tris(nonyl phenyl)phosphite, and distearyl pentaerythritol diphosphite. In yet a further aspect, the secondary antioxidant comprises tris(2,4-di-tert-butylphenyl)phosphite.

In some embodiments, the primary antioxidant is present in the combination, build material, or kit disclosed herein in a concentration of between about 1 and about 10,000 ppm mol/mol, between about 1 and about 8,000 ppm mol/mol, between about 100 and about 6,000 ppm mol/mol, between about 100 and about 5,000 ppm mol/mol, between about 500 and about 5,000 ppm mol/mol, between about 500 and about 4,000 ppm mol/mol, between about 500 and about 3,000 ppm mol/mol, between about 500 and about 2,500 ppm mol/mol, between about 1,000 and about 2,000 ppm mol/mol, or about 1,500 ppm mol/mol.

In some embodiments, the primary antioxidant is 4-tertbutylcatechol and the 4-tertbutylcatechol is present in the combination, build material, or kit disclosed herein in a concentration of between about 1 and about 10,000 ppm mol/mol, between about 1 and about 8,000 ppm mol/mol, between about 100 and about 6,000 ppm mol/mol, between about 100 and about 5,000 ppm mol/mol, between about 500 and about 5,000 ppm mol/mol, between about 500 and about 4,000 ppm mol/mol, between about 500 and about 3,000 ppm mol/mol, between about 500 and about 2,500 ppm mol/mol, between about 1,000 and about 2,000 ppm mol/mol, or about 1,500 ppm mol/mol.

### Catalyst Inhibitors

In some embodiments, the combination or build material further comprises a catalyst inhibitor. As used herein, a “a catalyst inhibitor” is a second chemical species which retards or ceases catalyst initiation or propagation. Catalyst inhibitors may be desirable for, e.g., preventing the premature polymerization during the preparation, purification, transportation and storage of the combination or build material. Suitable catalyst inhibitors include, but are not limited to, amines (e.g., alkyl amines, e.g., triethylamine, diisopropyl methyl amine), azaheterocycles (e.g., DBU (1,8-Diazabicyclo[5.4.0]undec-7-ene), DBN (1,5-Diazabicyclo[4.3.0]non-5-ene), and DABCO (1,4-diazabicyclo[2.2.2]octane), phosphites (e.g., trialkyl phosphites, triarylphosphites, and tribenzylphosphites), pyridines (e.g., 4-dimethylaminopyridine), and organic superbases, e.g., (amidine, guanidene, and phosphazene super bases).

### Photobase Generators

In some embodiments, the present disclosure provides means for selectively inhibiting polymerization. In some embodiment, the present disclosure provides means for selectively inhibiting a catalyst disclosed herein. In some embodiment, the present disclosure provides means for selectively inhibiting catalysis as disclosed herein. In some embodiments, the catalyst inhibitor is a photobase generator. In some embodiments, the combination or build material comprises a photobase generator (PBG). In some embodiments, the combination or build material does not comprise a means for selectively inhibiting catalysis. In some embodiments, the combination or build material does not comprise a photobase generator. Ruthenium-based metathesis catalysts may be susceptible to degradation via metallacyclobutane deprotonation using phosphines or amines. In certain applications of 3D printing, such as stereolithography, the PBG may be employed to selectively inhibit catalysis outside the desired print area. Without wishing to be bound by theory, PBGs may supply a steady concentration of base-typically an amine-via photolysis of a protecting group. Such photolysis may occur upon irradiation with UV light. In some embodiments, the wavelength of light that activates the PBG does not activate the curing catalyst. In some embodiments, the wavelength of light that activates the curing catalyst does not activate the PBG. Suitable photobase generators include, e.g., amines derivatized with nitrobenzyl groups (e.g., 2-nitrobenzyl tetramethyl guanidine carbamate, 4,5-dimethoxy-2-nitrobenzyl tetramethyl guanidine carbamate, and 2-(2-nitrophenyl)propyl tetramethyl guanidine carbamate).

As used herein, “selectively inhibiting” (e.g., selectively inhibiting a catalyst, selectively inhibiting polymerization, etc.) refers to an inhibition which occurs in a portion of a composition, in which inhibition does not occur in an adjacent portion.

### Optical Enhancement Components

In some embodiments, a combination or build material described herein are used in a method of fabricating an object, in which during fabrication, the achieved properties of a partially fabricated object are scanned, and information gained from that scanning is used to modify further addition of material so that the object matches the desired characteristics, for instance in dimension or composition. A number of different types of scanning techniques may make use of such emission, including laser profilometry (e.g., using confocal or geometric approaches), or structured light scanning (e.g., projection methods using incoherent light).

In some embodiments, a combination or build material described herein comprises an optical enhancement component. In some embodiments, the optical enhancement component into the material that changes the properties of the optical emission during fabrication. For example, the additive may increase the scattering of light from the material and/or cause fluorescence when excited. The additive may be incorporated at the time of printing (generally as described below), or may be incorporated much earlier, for example at the time that the fabrication material is prepared and stored for later use in fabrication. Optical scanning of nascent 3D printed objects, and optical enhancement components are described in WO2021086392, the contents of which are incorporated herein by reference.

Various types of additives may be used, including small molecule, macromolecule, supramolecular aggregate, protein, polymer, quantum dots, metal nano and micro particles (such as gold and silver nanoparticles, nanorods or nanoplates), non-metallic nano and microparticles (such as silica, zeolites, mesoporous particles, etc.) pigments, fine powder dispersions, etc. Another alternative additive includes a dye that degrades at a known rate under UV light exposure, so that it is only visible in the most recently deposited layer. The intensity at each point can be used to extract a depth map of the newly deposited layer. Upon subsequent exposure to the UV light during the 3D printing process from the successive layers, the dye will degrade and will not be visible when the product is in functional use. Another example uses OCT (Optical Coherence Tomography), which yields depth data and not merely a surface map. In the OCT case, the additives preferable enhance coherent scattering as opposed to scattering due to fluorescence. In yet another alternative, specific molecules are mixed within the fabrication material to determine whether polymerization has fully occurred. In this case, a determination would mean to assess whether the layer is fully cured, or if it needs an additional pass with UV light. In the life sciences literature for example, there are many fluorescent dyes that can be used to detect the presence of reactive oxygen species for example, unreacted monomers, as well as dies that can be used to determine the presence of other molecules. As an example, this catalog page from Thermo Fisher lists the fluorescent dies available for detecting ROSs. In general, additives may be used to detect the state of polymerization of a material during printing, and whether unwanted byproducts have been formed during UV light exposure. Such sensing is all part of determining whether the production process is proceeding correctly, but they extend beyond completeness, and even geometrical correctness. Of course it should be recognized that multiple additives may be combine to provide different types of emissions, for example, with some related to a degree of curing and others used to determine the surface or body structure of the object being fabricated.

Pure absorption can also be used, so that rather than brightening a response, the amount of the additive reduces the emission. Therefore “brightener” should be understood broadly merely to be a material that alters emission that may be sensed. Also, may be desirable that the emission not be visible to the human eye (in order to maintain the desired color or transparency of the fabricated object) but be visible to the detector, by using molecules that absorb in the UV region and emit in the visible, or for example gold nanorods that scatter only in the infrared region but are not visible to the human eye. As an alternative to adding different enhancers in the same material, adding a complex brighteners that, within themselves, contain different molecules that, acting together, perform some specific function. For example, it is possible to load fluorescent molecules within mesoporous silica nanoparticles of sizes in the range of 10-500 nm.

### Reinforcing Additives

In some embodiments, the compositions described herein can include reinforcing additives. In some embodiments, the reinforcing additives can include carbon fiber, fiber glass, cellulose fiber, material fibers (wood, jute) Polymer fibers (nylon, PVC, aramids, polyolefins, polyesters, polyurethanes), mineral fibers (asbestos).

### Flame Retardants

In some embodiments, the compositions described herein can include flame retardants. In some embodiments, the flame retardants can include organophosphorus materials, including phosphates (triphenyl phosphate, ammonium polyphosphate), phosphonates (dimethyl methyl phosphonate), and/or phosphinates (diethylphosphinate salts). In some embodiments, the flame retardants can include melamines (melamine, melamine cyanurate). In some embodiments, the flame retardants can include organohalogen materials, including chlorinated paraffins, chlorendic acid, organo bromines, decabrominated diphenyl ether, brominated polystyrene, hexabromocyclododecane, and/or tetrabromophisphenol A.

### Other Ingredients

In some embodiments, the combination or build material further comprises a stabilizer.

In some embodiments, the stabilizer is a thermal stabilizer (e.g., that stabilizes the combination or build material at an elevated temperature).

In some embodiments, the stabilizer is 4-tert-butylcatechol (TBC), 4-methoxyphenol (MEHQ), butylated hydroxytoluene (BHT), Hydroquinone (HQ), pentaerythritol tetrakis(3-(3,5-di-tert-butyl-4-hydroxyphenyl)propionate) (e.g., as sold under the name IRGANOX® 1010), ethylene bis(oxyethylene) bis-(3-(5-tert-butyl-4-hydroxy-m-tolyl)propionate) (e.g., as sold under the name IRGANOX® 245), octadecyl-[3-(3,5-di-tert-butyl-4-hydroxyphenyl)propionate](e.g., as sold under the name IRGANOX®1076), bis-(2,4-di-tert-butylphenol)pentaerythritol diphosphate (e.g., as sold under the name IRGAFOS® 126), tris(2,4-di-tert-butylphenyl)phosphite (e.g., as sold under the name IRGAFOS® 168), or any combination thereof.

In some embodiments, the combination or build material further comprises an impact modifier.

In some embodiments, the combination or build material further comprises a pigment, a dye, or a combination thereof.

In some embodiments, the combination or build material further comprises a pigment.

In some embodiments, the pigment is an organic pigment, an inorganic pigment, or a combination thereof.

In some embodiments, the combination or build material further comprises a dye.

In some embodiments, the dye is an organic dye, an inorganic dye, or a combination thereof.

Without wishing to be bound by theory, it is noted that the pigment or dye may enable the optical sensing (e.g., scanning) of the deposited material during printing. In some embodiments, the combination or build material containing the pigment or dye is colored, thereby enabling the optical sensing (e.g., scanning) of the deposited material by its color. In some embodiments, the combination or build material containing the pigment or dye is colorless but fluorescent, thereby enabling the optical sensing (e.g., scanning) of the deposited material by its fluorescence.

In some embodiments, the combination or build material further comprises a surface active agent, a filler, a pigment, a dispersant, or any combination thereof.

### Flame Retardants

In some embodiments, the compositions described herein can include flame retardants. In some embodiments, the flame retardants can include organophosphorus materials, including phosphates (triphenyl phosphate, ammonium polyphosphate), phosphonates (dimethyl methyl phosphonate), and/or phosphinates (diethylphosphinate salts). In some embodiments, the flame retardants can include melamines (melamine, melamine cyanurate). In some embodiments, the flame retardants can include organohalogen materials, including chlorinated paraffins, chlorendic acid, organo bromines, decabrominated diphenyl ether, brominated polystyrene, hexabromocyclododecane, and/or tetrabromophisphenol A.

### Properties of the Build Materials

In some embodiments, the build material has (e.g., at the temperature of jetting) a viscosity ranging from about 1 cp to about 100 cp, from about 2 cp to about 80 cp, from about 3 cp to about 70 cp, from about 4 cp to about 60 cp, from about 5 cp to about 50 cp, from about 6 cp to about 40 cp, from about 7 cp to about 30 cp, or from about 8 cp to about 20 cp.

In some embodiments, the build material has a viscosity ranging from about 1 cp to about 100 cp, from about 2 cp to about 80 cp, from about 3 cp to about 70 cp, from about 4 cp to about 60 cp, from about 5 cp to about 50 cp, from about 6 cp to about 40 cp, from about 7 cp to about 30 cp, or from about 8 cp to about 20 cp as measured at a temperature of about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 110° C., about 120° C., about 130° C., about 140° C., or about 150° C.

In some embodiments, the viscosity of the build material varies by about 10 cp or less, about 9 cp or less, about 8 cp or less, about 7 cp or less, about 6 cp or less, about 5 cp or less, about 4 cp or less, about 3 cp or less, about 2 cp or less, or about 1 cp or less, upon storage for two weeks (e.g., at the at the temperature of jetting).

In some embodiments, the viscosity of the build material varies by about 10 cp or less, about 9 cp or less, about 8 cp or less, about 7 cp or less, about 6 cp or less, about 5 cp or less, about 4 cp or less, about 3 cp or less, about 2 cp or less, or about 1 cp or less, upon storage for two weeks at a temperature of about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 110° C., about 120° C., about 130° C., about 140° C., or about 150° C.

In some embodiments, the cured build material has a tensile strength of about 20 MPa, about 25 MPa, about 30 MPa, about 35 MPa, about 40 MPa, about 45 MPa, about 50 MPa, about 55 MPa, about 60 MPa, about 65 MPa, about 70 MPa, about 75 MPa, about 80 MPa, about 85 MPa, about 90 MPa, about 95 MPa, about 100 MPa, or any range therebetween.

In some embodiments, the cured build material has an elongation at break of about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 100%, about 105%, about 110%, about 115%, about 120%, about 125%, about 130%, or any range therebetween.

In some embodiments, the cured build material has a Young's modulus of about 0.8 GPa, about 0.9 GPa, about 1.0 GPa, about 1.1 GPa, about 1.2 GPa, about 1.3 GPa, about 1.4 GPa, about 1.5 GPa, about 1.6 GPa, about 1.7 GPa, about 1.8 GPa, about 1.9 GPa, about 2.0 GPa, about 2.1 GPa, about 2.2 GPa, about 2.3 GPa, about 2.4 GPa, about 2.5 GPa, about 2.6 GPa, about 2.7 GPa, about 2.8 GPa, about 2.9 GPa, about 3.0 GPa, or any range therebetween.

In some embodiments, the cured build material has a notched Izod impact strength of about 5 J/m, about 10 J/m, about 20 J/m, about 30 J/m, about 40 J/m, about 50 J/m, about 100 J/m, about 150 J/m, about 200 J/m, about 250 J/m, about 300 J/m, about 350 J/m, about 400 J/m, about 450 J/m, about 500 J/m, about 550 J/m, about 600 J/m, about 650 J/m, about 700 J/m, about 750 J/m, about 800 J/m, or any range therebetween.

### Build Materials and Build Curing Conditions

In some embodiments, the build material is deposited (e.g., jetted) under a build depositing condition (e.g., build jetting condition).

In some embodiments, the build material is cured under a build curing condition.

In some embodiments, the build material is a liquid under the build depositing condition (e.g., the build jetting condition).

In some embodiments, upon deposition, the build material is converted to a solid by curing.

In some embodiments, the build material is UV curable.

In some embodiments, the build material is substantially stable (e.g., chemically and/or physically) toward the support material.

In some embodiments, the build material is substantially stable (e.g., chemically and/or physically) under the support curing condition.

In some embodiments, the build material is substantially stable (e.g., chemically and/or physically) toward the cured support material.

In some embodiments, upon activation, the curing catalyst cures the build material but does not cure the support material.

In some embodiments, the build curing condition comprises irradiation (e.g., visible light or UV).

In some embodiments, the build curing condition comprises an elevated temperature.

In some embodiments, the build curing condition comprises a chemical activation (e.g., adding water).

In some embodiments, the build curing condition comprises mechanical agitation. In some embodiments, the build curing condition comprises activation by acoustic (i.e., sonic) waves. In some embodiments, the build curing condition comprises activation by ultrasonic waves.

In some embodiments, the build curing condition is substantially free of air (e.g., oxygen).

In some embodiments, the build curing condition is substantially free of water.

In some embodiments, the cured build material is substantially stable (e.g., chemically and/or physically) toward the cured support material

In some embodiments, the cured build material is substantially stable (e.g., chemically and/or physically) under the support removal condition.

In some embodiments, the build material comprises a polymer.

In some embodiments, the polymer is formed by ring opening metathesis polymerization.

### Support Materials

In some embodiments, the support material is deposited (e.g., jetted) under a support depositing condition (e.g., support jetting condition).

In some embodiments, the support material is cured under a support curing condition.

In some embodiments, the support material or the cured support material is removed under a support removal condition.

In some embodiments, the support material is a liquid under the support depositing condition (e.g., the support jetting condition).

In some embodiments, the support material is a wax.

In some embodiments, the support material has a melting point being the same or lower than the temperature of the support depositing condition.

In some embodiments, upon deposition, the support material is converted to a solid (e.g., via a phase change).

In some embodiments, upon deposition, the support material is converted to a solid by cooling.

In some embodiments, upon deposition, the support material is converted to a solid by curing.

In some embodiments, the support material is UV curable.

In some embodiments, the support material is thermally curable.

In some embodiments, the support curing condition comprises irradiation (e.g., visible light or UV).

In some embodiments, the support curing condition comprises elevated temperature.

In some embodiments, the support curing condition comprises mechanical agitation. In some embodiments, the support curing condition comprises activation by acoustic (i.e., sonic) waves. In some embodiments, the support curing condition comprises activation by ultrasonic waves.

In some embodiments, the support curing condition is substantially free of air (e.g., oxygen).

In some embodiments, the support curing condition is substantially free of water.

In some embodiments, the cured support material is substantially stable (e.g., chemically and/or physically) toward the build material.

In some embodiments, the cured support material is substantially stable (e.g., chemically and/or physically) under the build curing condition.

In some embodiments, the cured support material comprises a polymer.

In some embodiments, the support removal condition comprises adding a solvent, thereby dissolving the cured support material.

In some embodiments, the support removal condition comprises mechanically removing the cured support material.

In some embodiments, the support removal condition comprises converting the support material from a solid to a liquid (e.g., via a phase change).

### Uses of Combinations, Materials, and Kits

In some aspects, the present disclosure provides a method of preparing a cured material, comprising a step of subjecting a combination, build material, or kit disclosed herein to a curing condition.

In some aspects, the present disclosure provides a combination, build material, or kit disclosed herein for use in preparing a cured material, wherein the preparation comprises a step of subjecting the combination, build material, or kit to a curing condition.

In some aspects, the present disclosure provides use of a combination, build material, or kit disclosed herein in the manufacture of a cured material, wherein the manufacture comprises a step of subjecting the combination, build material, or kit to a curing condition.

In some embodiments, the build curing condition comprises irradiation (e.g., visible light or UV).

In some embodiments, the build curing condition comprises an elevated temperature.

In some embodiments, the build curing condition comprises a chemical activation (e.g., adding water).

In some embodiments, the build curing condition comprises mechanical agitation. In some embodiments, the build curing condition comprises activation by acoustic (i.e., sonic) waves. In some embodiments, the build curing condition comprises activation by ultrasonic waves.

In some aspects, the present disclosure provides a cured material being prepared by a method described herein.

In some aspects, the present disclosure provides a method of printing an object using a combination, build material, or kit disclosed herein.

In some aspects, the present disclosure provides a combination, build material, or kit disclosed herein for use in printing an object.

In some aspects, the present disclosure provides a method of preparing a cured material, comprising:
(i) jetting a mixture comprising a composition as disclosed herein onto a bed of powder;
(ii) submitting the composition to a curing condition.

In some embodiments, the method comprises tuning the speed of the cyclic olefin resin polymerization, such that the thermoplastic fuses via heat before, concurrently and/or after initiation of the catalyst.

In some aspects, the present disclosure provides a method of preparing a cured material, comprising:
(i) injecting a comprising a composition as disclosed herein into a mold;
(ii) submitting the composition to a curing condition.

In some aspects, the present disclosure provides a method of preparing a cured material, comprising:
(i) applying comprising a composition as disclosed herein to a surface;
(ii) submitting the composition to a curing condition.

In some aspects, the printing comprises:
(i) depositing (e.g., jetting) a build material described herein;
(ii) submitting the deposited build material to a curing condition.

In some embodiments, the printing comprises:
(i) depositing (e.g., jetting) a build material described herein and
(ii) selectively subjecting a portion of the composition to a curing condition.

In some embodiments, the printing comprises:
(i) depositing (e.g., jetting) a first build material described herein, and a second build material described herein; and
(ii) subjecting the deposited first build material and deposited second build material to a curing condition.

In some embodiments, the printing comprises:
(i) depositing (e.g., jetting) a build material described herein onto a supporting material; and
(ii) subjecting the deposited build material to a curing condition.

In some embodiments, the printing comprises:
(i) depositing (e.g., jetting) a first build material described herein, and a second build material described herein, onto a supporting material; and
(ii) subjecting the deposited first build material and deposited second build material to a curing condition.

In some embodiments, the printing further comprises repeating the step of depositing the material for one or more time.

In some embodiments, the printing further comprises optically sensing the deposited material, and controlling the one or more repeated deposition of the material according to the sensing.

In some embodiments, the optionally sensing of the deposited material is performed when the material is at least partially cured.

In some embodiments, each repeated deposition of the material is performed when the previously deposited layer of the material is at least partially cured.

In some embodiments, the printing further comprises depositing an agent which enhances one or more of the mechanical, thermal, and/or optical properties of the material.

In some embodiments, sensing the deposited material comprises capturing a surface of the object being printed.

In some embodiments, the controlling one or more repeated deposition of the material is based on measurements of the volumetric/tomographic data of an object being printed.

In some embodiments, the printing further comprises heating the material, thereby facilitating the curing of the material.

### Systems for Using Combinations, Materials, and Kits

In some aspects, the present disclosure provides a system for 3D printing, comprising.
(i) a printer (e.g., an inkjet printer); and
(ii) an ink comprising a combination disclosed herein.

In some embodiments, the printer (e.g., the inkjet printer) comprises one or more printer jet; an optical feedback scanner; and a controller which controls the emission of the ink from the one or more printer jet according to the optical feedback of the jetted ink.

In some embodiments, the printer (e.g., the inkjet printer) further comprises a printing head loaded (e.g., a printing head loaded with the ink).

In some embodiments, the system further comprises a light source (e.g., a UV lamp or a visible-light lamp) configured to cure the deposited layers of the ink.

In some embodiments, the system further comprises a software comprising instructions stored on a non-transitory machine-readable medium, wherein execution of said instructions causes control of one or more of the printing steps described herein.

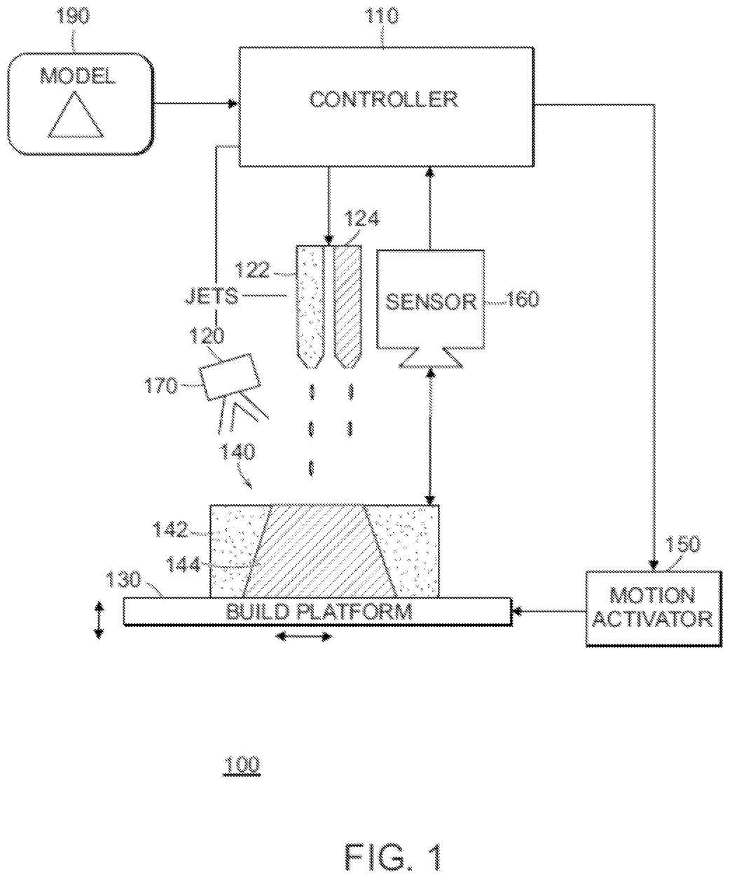

The description below relates an exemplary system for additive fabrication, e.g., using a jetting-based 3D printer 100 shown in FIG. 1. The printer 100 uses jets 120 (inkjets) to emit material for deposition on a partially fabricated objected layers. In the printer illustrated in FIG. 1, the object is fabricated on a build platform, which is controlled to move related to the jets in a raster-like pattern to form successive layers, and in this example also to move relative to the jets to maintain a desired separation of the jets and the surface of the partially-fabricated object. As illustrated, there are multiple jets 122, 124, with one jet 122 being used to emit a support material to form a support structure 142 of the object, and another jet 124 being used to emit built material to form the object 144 itself. For materials for which curing is triggered by an excitation signal, such as an ultraviolet illumination, a curing signal generator 170 (e.g., a UV lamp) triggers curing of the material shortly after it is jetted onto the object. In other embodiments, multiple different materials may be used, for example, with a separate jet being used for each material. Yet other implementations do not necessarily use an excitation signal (e.g., optical, RF, etc.) and rather the curing is triggered chemically, for example, by mixing multiple components before jetting, or jetting separate components that mix and trigger curing on the object. Note that in some examples, after the additive deposition is complete, the object may be subject to further curing (e.g., to complete the curing), for example, by further exposing the object to UV radiation.

A sensor 160 is used to determine physical characteristics of the partially fabricated object, including one or more of the surface geometry (e.g., a depth map characterizing the thickness/depth of the partially fabricated object), subsurface (e.g., in the near surface comprising, for example, 10s or 100s of deposited layers) characteristics. The characteristic that may be sensed can include one or more of a material density, material identification, and a curing state. Various types of sensing can be used, including triangulation scanning/profilometry; time-of-flight imaging (pulse based and phase-shift); active stereo methods/multi-baseline stereo/structured light; active depth from focus/defocus; interferometry; optical coherence tomography; shape from polarization; shape from heating; optical coherence tomography (OCT), laser profilometry, and/or as well as multi-spectral optical sensing, which may be used to distinguish different materials. In the illustrated printer, the sensor outputs a signal that may cause emission (e.g., fluorescence) and/or reflection, scattering, or absorption from or in the object. The sensor output signal may be provided from the top (i.e., the most recently deposited portion) of the object, while in some embodiments, the sensor output signal may come from below or other direction of the object.

Precision additive fabrication using inkjet technology has introduced use of optical-scanning-based feedback in order to adapt the deposition of material to achieve accurate object structure without requiring mechanical approaches that have been previously used. For example, such optical feedback techniques are described in U.S. Pat. Nos. 10,252,466 and 10,456,984 (incorporated by reference). However, optical feedback-based printers are not a prevalent commercial approach to 3D printing, perhaps due to the relative simplicity of approaches that do not achieve the precision attainable with optical feedback or that use mechanical approaches in conjunction with rapidly curing inks. Furthermore, many fabrication materials suitable for jetted additive fabrication are not directly suitable for optical scanning as inadequate optical signal strength may propagate from the material during scanning. For example, the material may be naturally substantially transparent and not reflect incident light suitably to be captured to yield an accurate characterization of the object being fabricated. However, with suitable incorporation of an optical enhancement component in the fabrication material, the ability to scan the material that has been deposited can be enhanced. Further details regarding suitable optical enhancement components may be found in PCT Appl'n No. PCT/US2019/59300 (incorporated herein by reference).

By not requiring contact to control the surface geometry of the object being manufactured, the approach can be tolerant of the relative slow curing of the composition (e.g., as compared to acrylate compositions usually used in inkjet 3D printing), while maintaining the benefit of control of the deposition processes according to feedback during the fabrication processes. This approach provides a way to manufacture precision objects and benefit from material properties of the fabricated objects, for example, with isotropic properties, which may be at least partially a result of the slow curing, and flexible structures, which may not be attainable using conventional jetted acrylates. Furthermore, in cases when ongoing curing after scanning may change the geometry of the part, for example, due to shrinkage, predictive techniques (e.g., using machine-learning approaches, e.g., as described in PCT Appl'n No. PCT/US2019/59567 (incorporated herein by reference)) may be used in the control process to predict such changes, further accommodating the cationic compositions into a precision jetted fabrication approach.

A controller 110 uses a model 190 of the object to be fabricated to control motion of the build platform 130 using a motion actuator 150 (e.g., providing three degree of motion) and control the emission of material from the jets 120 according to the non-contact feedback of the object characteristics determined via the sensor 160. Use of the feedback arrangement can produce a precision object by compensating for inherent unpredictable aspects of jetting (e.g., clogging of jet orifices) and unpredictable material changes after deposition, including for example, flowing, mixing, absorption, and curing of the jetted materials.

It is understood that the printer shown in FIG. 1 is merely illustrative but not limiting. Other printer arrangements that may be used are described, e.g., in U.S. Pat. Nos. 10,252,466 and 10,456,984, U.S. Appl'n Pub. No. 2018/0056582, and Sitthi-Amorn et al. (ACM Transactions on Graphics 34(4): 129 (2015)).

In an alternative manufacturing process, an additive fabrication stage and a subsequent or overlapping part curing stage imparts two distinct mechanisms to the build material for the part of the object: a phase change mechanism and a polymerization mechanism.

The phase change mechanism occurs during the additive fabrication stage and causes a phase change of the build material from a liquid to a non-liquid (e.g., at least partially solid, semi-solid, and/or quasi-solid), where the phase change is generally not due to polymerization. In this non-liquid form the build material is sufficiently solidified for subsequent incremental deposit of material on to it (e.g., the non-liquid build material can support the weight of incrementally added material and/or the force of the material as it is jetted to, for example, prevent mixing between the build material and the support material).

The polymerization mechanism occurs after, or at least partly after, the additive fabrication of the object during the curing stage. This mechanism cures the build material by a polymerization process. In some examples, the polymerization mechanism is initiated after additive fabrication of the object is complete. In other examples, the polymerization mechanism is initiated before additive manufacturing is complete, for example, being initiated during the phase change mechanism (e.g., with both mechanisms being initiated at the same time, or the polymerization mechanism being initiated during the phase change mechanism).

After the build material is sufficiently cured (e.g., sufficiently polymerized) in the curing stage to allow removal of the mold, the manufacturing process enters a part removal stage for removal of the mold. Removal of the mold yields the fabricated part.

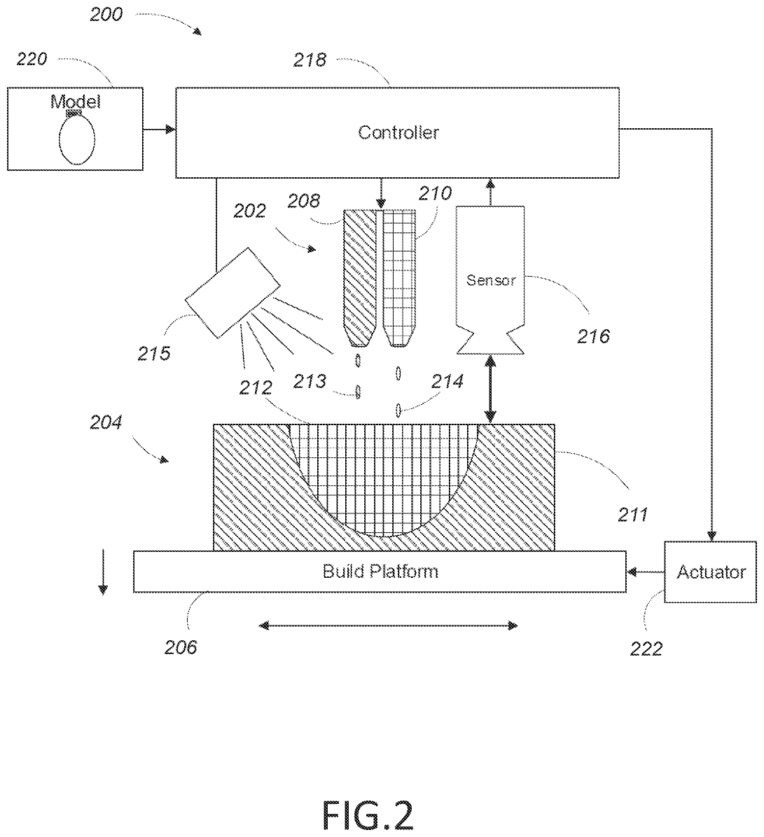

Referring to FIG. 2, this alternative manufacturing process uses a jetting-based 3D printer 200 as shown in FIG. 2. Very generally, the manufacturing process includes three temporal phases: an additive fabrication stage, a part curing stage, and a part removal stage. As is described in greater detail below, in some examples, the part curing stage occurs entirely after the additive fabrication stage. In other examples the additive fabrication stage and the part curing stage partially overlap.

In the additive fabrication stage, additive fabrication is used to fabricate an object 204 including a solid (e.g., cured) mold structure 211 that forms a cavity (e.g., closed structure or open vessel) defining a shape of the part 212, where the cavity is filled with a semi-solid, uncured or partially cured material in the shape of the part 212. The solid mold structure 211 and/or the semi-solid material are added, layer by layer, to form the object 204.

In the part curing stage, at least some of which occurs at a time after completion of the additive fabrication stage, the object 204 including the filled mold structure 211 undergoes a curing process for polymerizing the material in the cavity.

In the additive manufacturing stage and the part curing stage, the material used to form the part 212 (sometimes referred to as “build material) undergoes two distinct mechanisms: a phase change mechanism and a polymerization mechanism.

The phase change mechanism occurs during the additive fabrication stage and causes a phase change of the build material from a liquid to a non-liquid (e.g., at least partially solid, semi-solid, and/or quasi-solid, where these three terms may be used interchangeably herein). In this non-liquid form the build material is sufficiently solidified for subsequent incremental deposit of material on to it (e.g., the non-liquid build material can support the weight or force of incrementally added material).

The polymerization mechanism occurs after, or at least partly after, the additive fabrication of the object 204 during the curing stage. This mechanism cures the build material by a polymerization process. In some examples, the polymerization mechanism is initiated after additive fabrication of the object is complete. In other examples, the polymerization mechanism is initiated before additive manufacturing is complete, for example, being initiated during the phase change mechanism (e.g., with both mechanisms being initiated at the same time, or the polymerization mechanism being initiated after initiation and during the phase change mechanism).

In the part removal stage, the solid mold structure 211 is removed, yielding the part 212. In some examples, the part removal stage occurs after the part curing stage. But in other examples, the part removal stage may overlap with the part curing stage (e.g., the part 212 is still curing but is sufficiently cured for removal from the solid mold structure 211).

### Printer

In the additive fabrication stage, the printer 200 uses jets 202 (inkjets) to emit material for deposition of layers to form the object 204 (shown partially fabricated in FIG. 2). For the printer illustrated in FIG. 2, the object 204 is fabricated on a build platform 206, which is controlled to move relative to the jets (i.e., along an x-y plane) in a raster-like pattern to form successive layers, and in this example also to move relative to the jets (i.e., along a z-axis) to maintain a desired separation of the jets and the surface of the partially-fabricated object 204.

As illustrated, there are multiple jets 208, 210, for example with a first jet 208 being used to emit a mold material 213 to form a solid (e.g., cured or semi-cured) mold structure 211 of the object 204, and a second jet 210 being used to emit build material 214 to form an uncured or partially cured, semi-solid (e.g., a gel or a wax) part 212 in the object 204. Additional details of the properties of the mold material 213 and the build material 214 are described below.

A sensor 216 (sometimes referred to as a scanner) is positioned relative to (e.g., above) the object under fabrication 204 and is used to determine physical characteristics of the partially fabricated object. For example, the sensor 216 measures one or more of the surface geometry (e.g., a depth map characterizing the thickness/depth of the partially fabricated object) and subsurface characteristics (e.g., in the near surface comprising, for example, 10s or 100s of deposited layers). The characteristics that may be sensed can include one or more of a material density, material identification, and a curing state. Very generally, the measurements from the sensor 216 are associated with a three-dimensional (i.e., x, y, z) coordinate system where the x and y axes are treated as spatial axes in the plane of the build surface and the z axis is a height axis (i.e., growing as the object is fabricated).

In some examples, in the context of a digital feedback loop for additive fabrication, the additive manufacturing system builds the object by printing layers. The sensor 216 captures the 3D scan information after the printer 200 prints one or more layers. For example, the sensor 216 scans the partial object (or empty build platform), then the printer prints a layer (or layers) of material(s). Then, the sensor 216 scans the (partially built) object again. The new depth sensed by the sensor 216 should be at a distance that is approximately the old depth minus the thickness of layer (this assumes that the sensor 216 is positioned on the top of the of the object being built and the object is being built from the bottom layer to the top layer and the distance between the sensor 216 and the build platform is unchanged). Various types of sensing such as optical coherence tomography (OCT) or laser profilometry can be used to determine depth and volumetric information related to the object being fabricated.

A controller 218 uses a model 220 of the object to be fabricated to control motion of the build platform 206 using a motion actuator 222 (e.g., providing three degrees of motion) and control the emission of material from the jets 202 according to non-contact feedback of the object characteristics determined via the sensor 216.

### Definitions

Unless otherwise stated, the following terms used in the specification and claims have the following meanings set out below.

The articles “a” and “an” are used in this disclosure to refer to one or more than one (i.e., to at least one) of the grammatical object of the article. By way of example, “an element” means one element, at least one element, or more than one element.

As used herein, the term “ring-opening metathesis polymerization” or “ROMP” refers to a form of chain-growth polymerization in which the terminus of a polymer chain repeatedly reacts with a cyclic alkene monomer by olefin metathesis to form a longer polymer.

As used herein, the term “curing” refers to a process of converting a material by forming polymers and/or linking existing polymers in the material, thereby producing a cured material. In some embodiments, the conversion is initiated by radiation (e.g., UV or visible light), an elevated temperature, or an activator. In some embodiments, the conversion is initiated by radiation (e.g., UV or visible light).

As used herein, the term “about” refers to a range covering any normal fluctuations appreciated by one of ordinary skill in the relevant art. In some embodiments, the term “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

As used herein, the term “derivative” refers to compounds that have a common core structure as compared to the referenced compound and/or share one or more property with the referenced compound. In some embodiments, the derivatives are substituted with various groups as described herein as compared to the referenced compound.

Without wishing to be limited by this statement, it is understood that, while various options for variables are described herein, the disclosure intends to encompass operable embodiments having combinations of the options. The disclosure may be interpreted as excluding the non-operable embodiments caused by certain combinations of the options.

As used herein, “alkyl”, “C₁, C₂, C₃, C₄, C₅ or C₆ alkyl” or “C₁-C₆ alkyl” is intended to include C₁, C₂, C₃, C₄, C₅ or C₆ straight chain (linear) saturated aliphatic hydrocarbon groups and C₃, C₄, C₅ or C₆ branched saturated aliphatic hydrocarbon groups. For example, C₁-C₆ alkyl is intends to include C₁, C₂, C₃, C₄, C₅ and C₆ alkyl groups. Examples of alkyl include, moieties having from one to six carbon atoms, such as, but not limited to, methyl, ethyl, n-propyl, i-propyl, n-butyl, s-butyl, t-butyl, n-pentyl, i-pentyl, or n-hexyl. In some embodiments, a straight chain or branched alkyl has six or fewer carbon atoms (e.g., C₁-C₆ for straight chain, C₃-C₆ for branched chain), and in another embodiment, a straight chain or branched alkyl has four or fewer carbon atoms.

As used herein, the term “optionally substituted alkyl” refers to unsubstituted alkyl or alkyl having designated substituents replacing one or more hydrogen atoms on one or more carbons of the hydrocarbon backbone. Such substituents can include, for example, alkyl, alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moiety.

As used herein, the term “alkenyl” includes unsaturated aliphatic groups analogous in length and possible substitution to the alkyls described above, but that contain at least one double bond. For example, the term “alkenyl” includes straight chain alkenyl groups (e.g., ethenyl, propenyl, butenyl, pentenyl, hexenyl, heptenyl, octenyl, nonenyl, decenyl), and branched alkenyl groups. In certain embodiments, a straight chain or branched alkenyl group has six or fewer carbon atoms in its backbone (e.g., C₂-C₆ for straight chain, C₃-C₆ for branched chain). The term “C₂-C₆” includes alkenyl groups containing two to six carbon atoms. The term “C₃-C₆” includes alkenyl groups containing three to six carbon atoms.

As used herein, the term “optionally substituted alkenyl” refers to unsubstituted alkenyl or alkenyl having designated substituents replacing one or more hydrogen atoms on one or more hydrocarbon backbone carbon atoms. Such substituents can include, for example, alkyl, alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, heterocyclyl, alkylaryl, or an aromatic or heteroaromatic moiety.

As used herein, the term “alkynyl” includes unsaturated aliphatic groups analogous in length and possible substitution to the alkyls described above, but which contain at least one triple bond. For example, “alkynyl” includes straight chain alkynyl groups (e.g., ethynyl, propynyl, butynyl, pentynyl, hexynyl, heptynyl, octynyl, nonynyl, decynyl), and branched alkynyl groups. In certain embodiments, a straight chain or branched alkynyl group has six or fewer carbon atoms in its backbone (e.g., C₂-C₆ for straight chain, C₃-C₆ for branched chain). The term “C₂-C₆” includes alkynyl groups containing two to six carbon atoms. The term “C₃-C₆” includes alkynyl groups containing three to six carbon atoms. As used herein, “C₂-C₆ alkenylene linker” or “C₂-C₆ alkynylene linker” is intended to include C₂, C₃, C₄, C₅ or C₆ chain (linear or branched) divalent unsaturated aliphatic hydrocarbon groups. For example, C₂-C₆ alkenylene linker is intended to include C₂, C₃, C₄, C₅ and C₆ alkenylene linker groups.

As used herein, the term “optionally substituted alkynyl” refers to unsubstituted alkynyl or alkynyl having designated substituents replacing one or more hydrogen atoms on one or more hydrocarbon backbone carbon atoms. Such substituents can include, for example, alkyl, alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moiety.

As used herein, the term “cycloalkyl” refers to a saturated or partially unsaturated hydrocarbon monocyclic or polycyclic (e.g., fused, bridged, or spiro rings) system having 3 to 30 carbon atoms (e.g., C₃-C₁₂, C₃-C₁₀, or C₃-C₈). Examples of cycloalkyl include, but are not limited to, cyclopropyl, cyclobutyl, cyclopentyl, cyclohexyl, cycloheptyl, cyclooctyl, cyclopentenyl, cyclohexenyl, cycloheptenyl, 1,2,3,4-tetrahydronaphthalenyl, and adamantyl. In the case of polycyclic cycloalkyl, only one of the rings in the cycloalkyl needs to be non-aromatic.

As used herein, the term “heterocycloalkyl” refers to a saturated or partially unsaturated 3-8 membered monocyclic, 7-12 membered bicyclic (fused, bridged, or spiro rings), or 11-14 membered tricyclic ring system (fused, bridged, or spiro rings) having one or more heteroatoms (such as O, N, S, P, or Se), e.g., 1 or 1-2 or 1-3 or 1-4 or 1-5 or 1-6 heteroatoms, or e.g., 1, 2, 3, 4, 5, or 6 heteroatoms, independently selected from the group consisting of nitrogen, oxygen and sulfur, unless specified otherwise. Examples of heterocycloalkyl groups include, but are not limited to, piperidinyl, piperazinyl, pyrrolidinyl, dioxanyl, tetrahydrofuranyl, isoindolinyl, indolinyl, imidazolidinyl, pyrazolidinyl, oxazolidinyl, isoxazolidinyl, triazolidinyl, oxiranyl, azetidinyl, oxetanyl, thietanyl, 1,2,3,6-tetrahydropyridinyl, tetrahydropyranyl, dihydropyranyl, pyranyl, morpholinyl, tetrahydrothiopyranyl, 1,4-diazepanyl, 1,4-oxazepanyl, 2-oxa-5-azabicyclo[2.2.1]heptanyl, 2,5-diazabicyclo[2.2.1]heptanyl, 2-oxa-6-azaspiro[3.3]heptanyl, 2,6-diazaspiro[3.3]heptanyl, 1,4-dioxa-8-azaspiro[4.5]decanyl, 1,4-dioxaspiro[4.5]decanyl, 1-oxaspiro[4.5]decanyl, 1-azaspiro[4.5]decanyl, 3′H-spiro[cyclohexane-1,1′-isobenzofuran]-yl, 7′H-spiro[cyclohexane-1,5′-furo[3,4-b]pyridin]-yl, 3′H-spiro[cyclohexane-1,1′-furo[3,4-c]pyridin]-yl, 3-azabicyclo[3.1.0]hexanyl, 3-azabicyclo[3.1.0]hexan-3-yl, 1,4,5,6-tetrahydropyrrolo[3,4-c]pyrazolyl, 3,4,5,6,7,8-hexahydropyrido[4,3-d]pyrimidinyl, 4,5,6,7-tetrahydro-1H-pyrazolo[3,4-c]pyridinyl, 5,6,7,8-tetrahydropyrido[4,3-d]pyrimidinyl, 2-azaspiro[3.3]heptanyl, 2-methyl-2-azaspiro[3.3]heptanyl, 2-azaspiro[3.5]nonanyl, 2-methyl-2-azaspiro[3.5]nonanyl, 2-azaspiro[4.5]decanyl, 2-methyl-2-azaspiro[4.5]decanyl, 2-oxa-azaspiro[3.4]octanyl, 2-oxa-azaspiro[3.4]octan-6-yl, 5,6-dihydro-4H-cyclopenta[b]thiophenyl, and the like. In the case of multicyclic heterocycloalkyl, only one of the rings in the heterocycloalkyl needs to be non-aromatic (e.g., 4,5,6,7-tetrahydrobenzo[c]isoxazolyl).

As used herein, the term “aryl” includes groups with aromaticity, including “conjugated,” or multicyclic systems with one or more aromatic rings and do not contain any heteroatom in the ring structure. The term aryl includes both monovalent species and divalent species. Examples of aryl groups include, but are not limited to, phenyl, biphenyl, naphthyl and the like. Conveniently, an aryl is phenyl.

As used herein, the term “heteroaryl” is intended to include a stable 5-, 6-, or 7-membered monocyclic or 7-, 8-, 9-, 10-, 11- or 12-membered bicyclic aromatic heterocyclic ring which consists of carbon atoms and one or more heteroatoms, e.g., 1 or 1-2 or 1-3 or 1-4 or 1-5 or 1-6 heteroatoms, or e.g., 1, 2, 3, 4, 5, or 6 heteroatoms, independently selected from the group consisting of nitrogen, oxygen and sulfur. The nitrogen atom may be substituted or unsubstituted (i.e., N or NR wherein R is H or other substituents, as defined). The nitrogen and sulfur heteroatoms may optionally be oxidised (i.e., N→O and S(O)ₚ, where p=1 or 2). It is to be noted that total number of S and O atoms in the aromatic heterocycle is not more than 1. Examples of heteroaryl groups include pyrrole, furan, thiophene, thiazole, isothiazole, imidazole, triazole, tetrazole, pyrazole, oxazole, isoxazole, isothiazole, pyridine, pyrazine, pyridazine, pyrimidine, and the like. Heteroaryl groups can also be fused or bridged with alicyclic or heterocyclic rings, which are not aromatic so as to form a multicyclic system (e.g., 4,5,6,7-tetrahydrobenzo[c]isoxazolyl). In some embodiments, the heteroaryl is thiophenyl or benzothiophenyl. In some embodiments, the heteroaryl is thiophenyl. In some embodiments, the heteroaryl benzothiophenyl.

Furthermore, the terms “aryl” and “heteroaryl” include multicyclic aryl and heteroaryl groups, e.g., tricyclic, bicyclic, e.g., naphthalene, benzoxazole, benzodioxazole, benzothiazole, benzoimidazole, benzothiophene, quinoline, isoquinoline, naphthrydine, indole, benzofuran, purine, benzofuran, deazapurine, indolizine.

The cycloalkyl, heterocycloalkyl, aryl, or heteroaryl ring can be substituted at one or more ring positions (e.g., the ring-forming carbon or heteroatom such as N) with such substituents as described above, for example, alkyl, alkenyl, alkynyl, halogen, hydroxyl, alkoxy, alkylcarbonyloxy, arylcarbonyloxy, alkoxycarbonyloxy, aryloxycarbonyloxy, carboxylate, alkylcarbonyl, alkylaminocarbonyl, aralkylaminocarbonyl, alkenylaminocarbonyl, alkylcarbonyl, arylcarbonyl, aralkylcarbonyl, alkenylcarbonyl, alkoxycarbonyl, aminocarbonyl, alkylthiocarbonyl, phosphate, phosphonato, phosphinato, amino (including alkylamino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moiety. Aryl and heteroaryl groups can also be fused or bridged with alicyclic or heterocyclic rings, which are not aromatic so as to form a multicyclic system.

As used herein, the term “substituted,” means that any one or more hydrogen atoms on the designated atom is replaced with a selection from the indicated groups, provided that the designated atom's normal valency is not exceeded, and that the substitution results in a stable compound. When a substituent is oxo or keto (i.e., ═0), then 2 hydrogen atoms on the atom are replaced. Keto substituents are not present on aromatic moieties. Ring double bonds, as used herein, are double bonds that are formed between two adjacent ring atoms (e.g., C═C, C═N or N═N). “Stable compound” and “stable structure” are meant to indicate a compound that is sufficiently robust to survive isolation to a useful degree of purity from a reaction mixture, and formulation into an efficacious polymeric material.

As used herein, the term “inert” refers to a moiety which is not chemically reactive, i.e., it does not react with other moieties or reagents. The person skilled in the art understands that the term “inert” does not per se exclude the presence of functional groups, but understands that the functional groups potentially present in an inert moiety are not reactive with functional groups of moieties/reagents brought in contact with the inert moiety.

As used herein, the term “inert atmosphere” refers to a substantially oxygen free environment and primarily consists of non-reactive gases. Exemplary inert atmospheres include a nitrogen atmosphere or an argon atmosphere.

The term “inert solvent”, as used herein, refers to a solvent that cannot participate in, or inhibit, a polymerization reaction as disclosed herein. A skilled artisan will recognize that, in the context of the materials and methods disclosed herein, an inert solvent may be a solvent that does not comprise any of the functional groups identified as a catalyst inhibitor herein. Exemplary inert solvents can non-polar solvent such as hexane, toluene, diphenyl ether, chloroform, ethyl acetate, THF, dichloromethane; polar aprotic solvents such as acetonitrile, acetone, dichlorobenzene, N,N-dimethylformamide, N,N-dimethylacetamide, dimethyl sulfoxide, and polar protic solvents such as lower alcohol and water. A skilled artisan will recognize that the status of “inert”, as applied to a solvent, depends on the specific compounds to be dissolved therein, and can readily ascertain, by conventional means, whether a given solvent is appropriately inert under the circumstances.

When a bond to a substituent is shown to cross a bond connecting two atoms in a ring, then such substituent may be bonded to any atom in the ring. When a substituent is listed without indicating the atom via which such substituent is bonded to the rest of the compound of a given formula, then such substituent may be bonded via any atom in such formula. Combinations of substituents and/or variables are permissible, but only if such combinations result in stable compounds.

When any variable (e.g., R) occurs more than one time in any constituent or formula for a compound, its definition at each occurrence is independent of its definition at every other occurrence. Thus, for example, if a group is shown to be substituted with 0-2 R moieties, then the group may optionally be substituted with up to two R moieties and R at each occurrence is selected independently from the definition of R. Also, combinations of substituents and/or variables are permissible, but only if such combinations result in stable compounds.

As used herein, the term “hydroxy” or “hydroxyl” includes groups with an —OH or —O.

As used herein, the term “halo” or “halogen” refers to fluoro, chloro, bromo and iodo.

As used herein, the term “alkoxy” or “alkoxyl” includes substituted and unsubstituted alkyl, alkenyl and alkynyl groups covalently linked to an oxygen atom. Examples of alkoxy groups or alkoxyl radicals include, but are not limited to, methoxy, ethoxy, isopropyloxy, propoxy, butoxy and pentoxy groups. Examples of substituted alkoxy groups include halogenated alkoxy groups. The alkoxy groups can be substituted with groups such as alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moieties. Examples of halogen substituted alkoxy groups include, but are not limited to, fluoromethoxy, difluoromethoxy, trifluoromethoxy, chloromethoxy, dichloromethoxy and trichloromethoxy.

As used herein, “latent catalyst” refers to a compound that shows little or no catalytic activity under certain conditions (e.g., those conditions present prior to printing) and initiate such activity when activated (e.g., under curing conditions). Latent catalysts may be activated by a variety of conditions, including without any limitation acid and radical activation. As used herein, the term “latent ruthenium complex” refers to organo-ruthenium compounds which are latent catalysts.

As used herein, the expressions “one or more of A, B, or C,” “one or more A, B, or C,” “one or more of A, B, and C,” “one or more A, B, and C,” “selected from the group consisting of A, B, and C”, “selected from A, B, and C”, and the like are used interchangeably and all refer to a selection from a group consisting of A, B, and/or C, i.e., one or more As, one or more Bs, one or more Cs, or any combination thereof, unless indicated otherwise.

As used herein, the term “pigment” refers to a colored, black, white, or fluorescent particulate organic or inorganic solid. In some embodiments, the pigment insoluble in, and essentially physically and chemically unaffected by, the vehicle or substrate in which it is incorporated. In some embodiments, the pigment alters appearance by selective absorption and/or by scattering of light. In some embodiments, the pigment is dispersed in vehicles or substrates for application, as for instance in the manufacture or inks or other polymeric materials. In some embodiments, the pigment retains a crystal or particulate structure throughout the coloration process.

As used herein, the term “dye” refers to an intensely colored or fluorescent organic substances which imparts color to a substrate by selective absorption of light. In some embodiments, the dye is soluble and/or goes through an application process which, at least temporarily, destroys any crystal structure by absorption, solution, and mechanical retention, or by ionic or covalent chemical bonds.

As used herein, the term “viscosity” refers to the ability of a composition (e.g., the formulation of the present disclosure) to resist deformation at a given rate.

As used herein, the term “elongation at break” refers to the ratio between increased length and initial length after breakage of the tested specimen at a controlled temperature. In some embodiments, the elongation at break is measured by the ASTM D412, ASTM D624, or ASTM D638.

As used herein, the term “Young's modulus” refers to a mechanical property that measures the stiffness of a solid material. Young's modulus is associated with the relationship between stress (force per unit area) and strain (proportional deformation) in a material in the linear elasticity regime of a uniaxial deformation. In some embodiments, the Young's modulus is measured by the ASTM D412, ASTM D624, or ASTM D638.

As used herein, the term “notched Izod impact strength” refers to a mechanical property that measures the impact resistance of a solid material. In some embodiments, it is measured by a method in which a pivoting arm is raised to a specific height (constant potential energy) and then released. The arm swings down hitting a notched sample, breaking the specimen. The energy absorbed by the sample is calculated from the height the arm swings to after hitting the sample. A notched sample is generally used to determine impact energy and notch sensitivity. Notched Izod impact strength is associated with the energy lost per unit of thickness (e.g., J/cm) at the notch. In some embodiments, the notched Izod impact strength is measured by the ASTM D256.

It is to be understood that the present disclosure provides methods for the synthesis of the compounds described herein. The present disclosure also provides detailed methods for the synthesis of various disclosed compounds of the present disclosure according to the following schemes as well as those shown in the Examples.

It is to be understood that, throughout the description, where compositions are described as having, including, or comprising specific components, it is contemplated that compositions also consist essentially of, or consist of, the recited components. Similarly, where methods or processes are described as having, including, or comprising specific process steps, the processes also consist essentially of, or consist of, the recited processing steps. Further, it should be understood that the order of steps or order for performing certain actions is immaterial so long as the invention remains operable. Moreover, two or more steps or actions can be conducted simultaneously.

It is to be understood that compounds of the present disclosure can be prepared in a variety of ways using commercially available starting materials, compounds known in the literature, or from readily prepared intermediates, by employing standard synthetic methods and procedures either known to those skilled in the art, or which will be apparent to the skilled artisan in light of the teachings herein. Standard synthetic methods and procedures for the preparation of organic molecules and functional group transformations and manipulations can be obtained from the relevant scientific literature or from standard textbooks in the field. Although not limited to any one or several sources, classic texts such as Smith, M. B., March, J., March's Advanced Organic Chemistry: Reactions, Mechanisms, and Structure, 5^{th} edition, John Wiley & Sons: New York, 2001; Greene, T. W., Wuts, P. G. M., Protective Groups in Organic Synthesis, 3^{rd} edition, John Wiley & Sons: New York, 1999; R. Larock, Comprehensive Organic Transformations, VCH Publishers (1989); L. Fieser and M. Fieser, Fieser and Fieser's Reagents for Organic Synthesis, John Wiley and Sons (1994); and L. Paquette, ed., Encyclopedia of Reagents for Organic Synthesis, John Wiley and Sons (1995), incorporated by reference herein, are useful and recognized reference textbooks of organic synthesis known to those in the art

One of ordinary skill in the art will note that, during the reaction sequences and synthetic schemes described herein, the order of certain steps may be changed, such as the introduction and removal of protecting groups. One of ordinary skill in the art will recognize that certain groups may require protection from the reaction conditions via the use of protecting groups. Protecting groups may also be used to differentiate similar functional groups in molecules. A list of protecting groups and how to introduce and remove these groups can be found in Greene, T. W., Wuts, P. G. M., Protective Groups in Organic Synthesis, 3^{rd} edition, John Wiley & Sons: New York, 1999.

All percentages and ratios used herein, unless otherwise indicated, are by weight. Other features and advantages of the present disclosure are apparent from the different examples. The provided examples illustrate different components and methodology useful in practicing the present disclosure. The examples do not limit the claimed disclosure. Based on the present disclosure the skilled artisan can identify and employ other components and methodology useful for practicing the present disclosure.

All publications and patent documents cited herein are incorporated herein by reference as if each such publication or document was specifically and individually indicated to be incorporated herein by reference. Citation of publications and patent documents is not intended as an admission that any is pertinent prior art, nor does it constitute any admission as to the contents or date of the same. The invention having now been described by way of written description, those of skill in the art will recognize that the invention can be practiced in a variety of embodiments and that the foregoing description and examples below are for purposes of illustration but not limitation.

### EXAMPLES

### Example 1. Radical Photoinitiation of a Latent Ruthenium Catalyst

A composition comprising HeatMet, ethyl (2,4,6-trimethylbenzoyl) phenyl phosphinate (TPO-L), and dicyclopentadiene was prepared. Upon exposure to UV light, the composition underwent fast photoinitiation with a high degree of final cure, comparable to the composition of HeatMet, isopropyl thioxanthone (ITX), and ethyl 4-dimethylaminobenzoate (EDAB) reported in ACS Appl. Polym. Mater. 2019, 1, 8, 2177-2188. Notably, ITX possesses both photosensitizer and Norrish Type II photoinitiator activity, while TPO-L only possesses Norrish Type 1 photoinitiator activity, with no reported photosenisitizer activity. Without wishing to be bound by theory, this suggests that this polymerization is proceeding via free radical initiation of the HeatMet catalyst.

### Example 2. Radical Photoinitiation of a Latent Ruthenium Catalyst

A composition consistent with that shown in Table 2 was prepared. Upon exposure to UV light, the composition underwent fast photoinitiation with a high degree of final cure. The composition of Example 2 showed an initial cure rate approximately one hundred-fold faster than that of the composition of HeatMet, isopropyl thioxanthone (ITX), and ethyl 4-dimethylaminobenzoate (EDAB) reported in ACS Appl. Polym. Mater. 2019, 1, 8, 2177-2188. The composition of Example 2 also showed a usable storage life of more than 2 days, as compared to the usable storage life of less than 2 hours reported for the literature composition.

TABLE 2
Composition of Example 2

| Chemical Name | Chemical Structure | Role | Concentration |
|---|---|---|---|
| Tetracyclo[6.2.1.13,6.02,7] dodec-4-ene (Compound 26) | 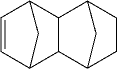 [SMILES: C1=CC2CC1C1C3CCC(C3)C21] | ROMP Precursor | Neat |
| HeatMet (Catalyst 1) | 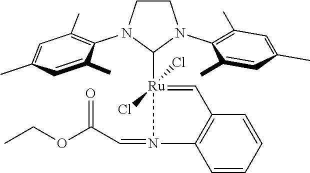 | Curing Catalyst | 100 ppm mol/mol |
| 2-isopropylthioxanthone (ITX) | 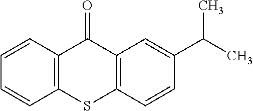 [SMILES: CC(C)c1ccc2sc3ccccc3c(=O)c2c1] | Photoinitiator | 2,000 ppm mol/mol |
| Ethyl 4-(dimethylamino) benzoate | 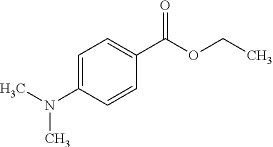 | Synergist | 2,000 ppm mol/mol |
| 4-tertbutyl catechol | 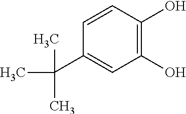 | Primary Antioxidant | 1,500 ppm mol/mol |

### EQUIVALENTS

The details of one or more embodiments of the disclosure are set forth in the accompanying description above. Although any methods and materials similar or equivalent to those described herein can be used in the practice or testing of the present disclosure, the preferred methods and materials are now described. Other features, objects, and advantages of the disclosure will be apparent from the description and from the claims. In the specification and the appended claims, the singular forms include plural referents unless the context clearly dictates otherwise. Unless defined otherwise, all technical and scientific terms used herein have the same meaning as commonly understood by one of ordinary skill in the art to which this disclosure belongs. All patents and publications cited in this specification are incorporated by reference.

The foregoing description has been presented only for the purposes of illustration and is not intended to limit the disclosure to the precise form disclosed, but by the claims appended hereto.

### Numbered Embodiments

1. A combination comprising:
(i) a ring-opening-metathesis-polymerization (ROMP) precursor;
(ii) a latent curing catalyst; and
(iii) a free radical initiator.

2. A build material comprising the combination of embodiment 1.

3. A kit comprising the combination of any one of the preceding embodiments.

4. A kit comprising:
a build material comprising:
   (i) a ROMP precursor;
   (ii) a latent curing catalyst; and
   (iii) a free radical initiator; and
a support material.

5. A kit comprising:
a first build material comprising:
   (i) a ROMP precursor; and
   (ii) a curing catalyst;
a second build material comprising:
   (iii) a ROMP precursor; and
   (iv) a free radical initiator; and
a support material.

6. A kit comprising:
a first build material comprising
   (i) a ROMP precursor; and
   (ii) a free radical initiator
a second build material comprising
   (iii) a curing catalyst; and
   (iv) an inert solvent; and
a support material.

7. The combination, build material, or kit of any one of the preceding embodiments, wherein the ROMP precursor is a compound of Formula (M-I):

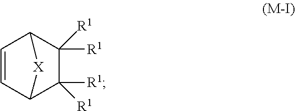

or a salt thereof, wherein:
X is CH₂ or O;
each R¹ independently:
   (a) is H, halogen, cyano, —OR^{1A}, —SR^{1A}, —C(═O)—R^{1A}, —C(═O)—OR^{1A}, —O—C(═O)—R^{1A}, —C(═O)—N(R^{1A})₂, —C(═O)—NHR^{1A}, —NH—C(═O)—R^{1A}, —N(R^{1A})₂, —Si(R^{1A})₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1A}; or
   (b) together with another R¹ and the atoms to which they attach, form a bond, C₃-C₂₀ cycloalkyl, C₆-C₂₀ aryl, 3- to 20-membered heterocycloalkyl, or 5- to 20-membered heteroaryl, wherein the C₃-C₂₀ cycloalkyl, C₆-C₂₀ aryl, 3- to 20-membered heterocycloalkyl, or 5- to 20-membered heteroaryl is optionally substituted with one or more R^{1A};
each R^{1A} independently:
   (a) is H, halogen, cyano, —OR^{1B}, —SR^{1B}, —C(═O)—R^{1B}, —C(═O)—OR^{1B}, —O—C(═O)—R^{1B}, —C(═O)—N(R^{1B})₂, —C(═O)—NHR^{1B}, —NH—C(═O)—R^{1B}, —N(R^{1B})₂, —Si(R^{1B})₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1B}; or
   (b) together with another R^{1A} and the atoms to which they attach, form a bond, C₃-C₂₀ cycloalkyl, C₆-C₂₀ aryl, 3- to 20-membered heterocycloalkyl, or 5- to 20-membered heteroaryl, wherein the C₃-C₂₀ cycloalkyl, C₆-C₂₀ aryl, 3- to 20-membered heterocycloalkyl, or 5- to 20-membered heteroaryl is optionally substituted with one or more R^{1B}.
each R^{1B} independently is H, halogen, cyano, —OR^{1C}, —SR^{1C}, —C(═O)—R^{1C}, —C(═O)—OR^{1C}, —O—C(═O)—R^{1C}, —C(═O)—N(R^{1C})₂, —C(═O)—NHR^{1C}, —NH—C(═O)—R^{1C}, —N(R^{1C})₂, —Si(R^{1C})₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1C};
each R^{1C} independently is H, halogen, cyano, —OR^{1D}, —SR^{1D}, —C(═O)—R^{1D}, —C(═O)—OR^{1D}, —O—C(═O)—R^{1D}, —C(═O)—N(R^{1D})₂, —C(═O)—NHR^{1D}, —NH—C(═O)—R^{1D}, —N(R^{1D})₂, —Si(R^{1D})₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1D}; and
each R^{1D} independently is H, halogen, cyano, —OH, —NH₂, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl.

8. The combination, build material, or kit of any one of the preceding embodiments, wherein X is CH₂.

9. The combination, build material, or kit of any one of the preceding embodiments, wherein X is O.

10. The combination, build material, or kit of any one of the preceding embodiments, wherein at least one R¹ is H.

11. The combination, build material, or kit of any one of the preceding embodiments, wherein at least one R¹ is halogen, cyano, —OR^{1A}, —SR^{1A}, —C(═O)—R^{1A}, —C(═O)—OR^{1A}, —O—C(═O)—R^{1A}, —C(═O)—N(R^{1A})₂, —C(═O)—NHR^{1A}, —NH—C(═O)—R^{1A}, —N(R^{1A})₂, —Si(R^{1A})₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1A}.

12. The combination, build material, or kit of any one of the preceding embodiments, wherein at least two R¹, together with the atoms to which they attach, form a bond, C₃-C₂₀ cycloalkyl, C₆-C₂₀ aryl, 3- to 20-membered heterocycloalkyl, or 5- to 20-membered heteroaryl, wherein the C₃-C₂₀ cycloalkyl, C₆-C₂₀ aryl, 3- to 20-membered heterocycloalkyl, or 5- to 20-membered heteroaryl is optionally substituted with one or more R^{1A}.

13. The combination, build material, or kit of any one of the preceding embodiments, wherein at least one R^{1A} is H.

14. The combination, build material, or kit of any one of the preceding embodiments, wherein at least one R^{1A} is halogen, cyano, —OR^{1B}, —SR^{1B}, —C(═O)—R^{1B}, —C(═O)—OR^{1B}, —O—C(═O)—R^{1B}, —C(═O)—N(R^{1B})₂, —C(═O)—NHR^{1B}, —NH—C(═O)—R^{1B}, —N(R^{1B})₂, —Si(R^{1B})₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1B}.

15. The combination, build material, or kit of any one of the preceding embodiments, wherein at least two R^{1A}, together with the atoms to which they attach, form a bond, C₃-C₂₀ cycloalkyl, C₆-C₂₀ aryl, 3- to 20-membered heterocycloalkyl, or 5- to 20-membered heteroaryl, wherein the C₃-C₂₀ cycloalkyl, C₆-C₂₀ aryl, 3- to 20-membered heterocycloalkyl, or 5- to 20-membered heteroaryl is optionally substituted with one or more R^{1B}.

16. The combination, build material, or kit of any one of the preceding embodiments, wherein the ROMP precursor is a compound of:

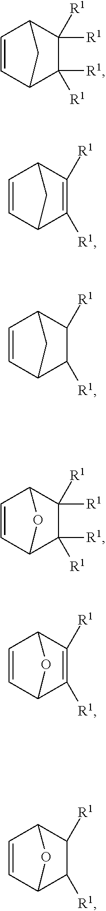

or a salt thereof.

17. The combination, build material, or kit of any one of the preceding embodiments, wherein the ROMP precursor is a compound of:

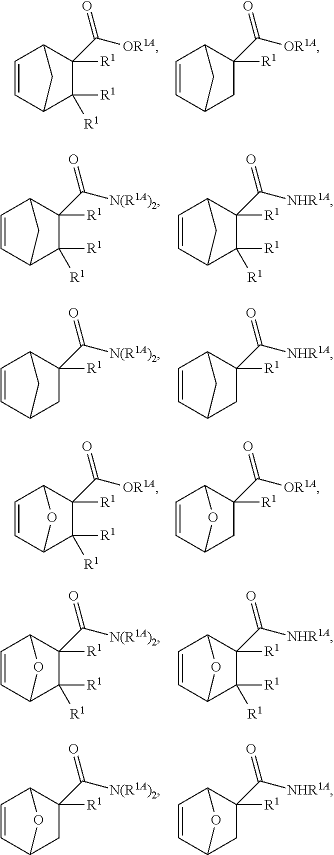

or a salt thereof.

18. The combination, build material, or kit of any one of the preceding embodiments, wherein the ROMP precursor is a compound of:

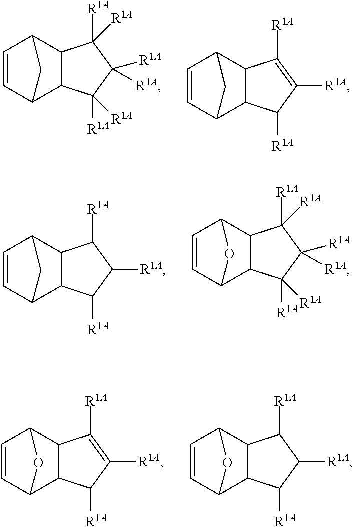

or a salt thereof.

19. The combination, build material, or kit of any one of the preceding embodiments, wherein the ROMP precursor is a compound of:

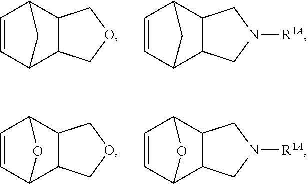

or a salt thereof.

20. The combination, build material, or kit of any one of the preceding embodiments, wherein the ROMP precursor is a compound of

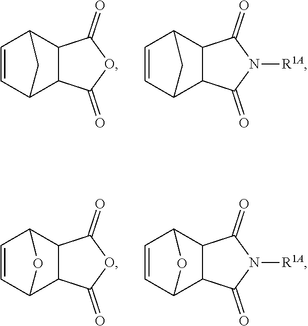

or a salt thereof.

21. The combination, build material, or kit of any one of the preceding embodiments, wherein the ROMP precursor is a compound of:

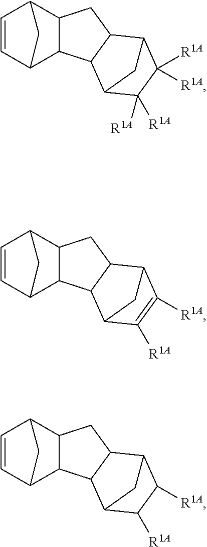

or a salt thereof.

22. The combination, build material, or kit of any one of the preceding embodiments, wherein the ROMP precursor is a compound of:

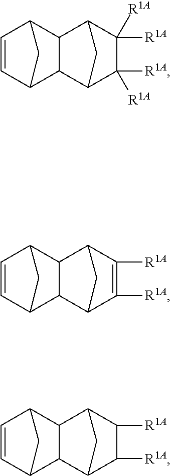

or a salt thereof.

23. The combination, build material, or kit of any one of the preceding embodiments, wherein the ROMP precursor is a compound of:

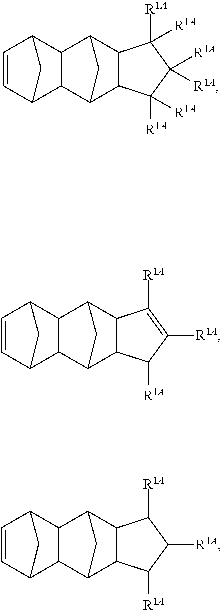

or a salt thereof.

24. The combination, build material, or kit of any one of the preceding embodiments, wherein the ROMP precursor is selected from the compounds described in Table 1 and salts thereof.

25. The combination, build material, or kit of any one of the preceding embodiments, wherein the curing catalyst is a latent catalyst.

26. The combination, build material, or kit of any one of the preceding embodiments, wherein the curing catalyst is a ruthenium catalyst.

27. The combination, build material, or kit of any one of the preceding embodiments, wherein the curing catalyst is Grubbs catalyst.

28. The combination, build material, or kit of any one of the preceding embodiments, wherein the curing catalyst is a latent ruthenium complex.

29. The combination, build material, or kit of any one of the preceding embodiments, wherein the curing catalyst is a compound of formula (C-I):

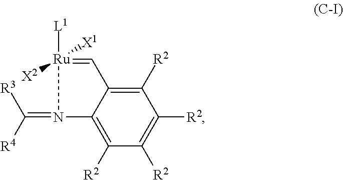

wherein
L¹ is

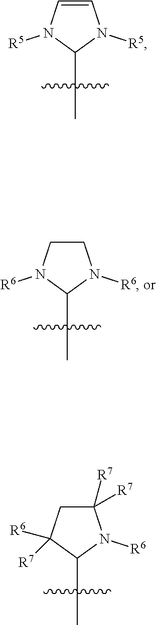

X¹ and X² are each independently halogen, C₁₋₂₄alkoxy, or thiolate;
Each R² is independently hydrogen, halogen, OH, C₁₋₂₄alkyl, C₁₋₂₄alkoxy, C₁₋₂₄ fluoroalkyl, C₁₋₂₄fluoroalkoxy, C₁₋₂₄alkylhydroxy, C₁₋₂₄alkoxyhydroxy, C₁₋₂₄fluoroalkylhydroxy, C₁₋₂₄fluoroalkoxyhydroxy, C₃-C₂₀ cycloalkyl, C₆-C₂₀ aryl, 3- to 20-membered heterocycloalkyl, 5- to 20-membered heteroaryl, NO₂, NR⁸R⁹, OC(O)R¹⁰, C(O)OR¹⁰, NR¹¹C(O)R¹⁰, C(O)NR¹¹R¹⁰, cyano, nitro, silyl, or phosphonyl; R³ is hydrogen, C₁₋₂₄alkyl, C₃-C₂₀ cycloalkyl, C₆-C₂₀ aryl, 3- to 20-membered heterocycloalkyl, 5- to 20-membered heteroaryl, OC(O)R¹², C(O)OR¹², NR¹³C(O)R¹², or C(O)NR¹²R¹³,
R⁴ is hydrogen, C₁₋₂₄alkyl, C₃-C₂₀ cycloalkyl, or C₆-C₂₀ aryl;
Each R⁵ is independently C₆-C₂₀ aryl wherein the aryl is optionally substituted by one or more R¹⁴;
Each R⁶ is independently C₁₋₂₄alkyl or C₆-C₂₀ aryl, wherein the alkyl or aryl is optionally substituted by one or more R¹⁴,
Each R⁷ is independently hydrogen or C₁₋₂₄alkyl wherein the alkyl is optionally substituted by one or more R¹⁴; and
Each R⁸, R⁹, R¹⁰, R¹¹, R¹², R¹³ and R¹⁴ is independently hydrogen, C₁₋₂₄alkyl, C₃-C₂₀ cycloalkyl, or C₆-C₂₀ aryl.

30. The combination, build material, or kit of any one of the preceding embodiments, wherein the curing catalyst is a compound of formula (C-II):

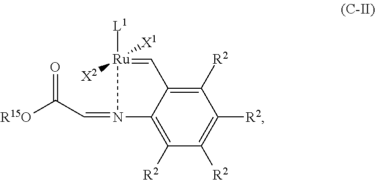

wherein R⁵ is hydrogen, C₁₋₂₄alkyl, C₃-C₂₀ cycloalkyl, C₆-C₂₀ aryl, 3- to 20-membered heterocycloalkyl, or 5- to 20-membered heteroaryl.

31. The combination, build material, or kit of any one of the preceding embodiments, wherein the curing catalyst is activated by a free radical initiator.

32. The combination, build material, or kit of any one of the preceding embodiments, wherein the curing catalyst is activated by a radical photoinitiator.

33. The combination, build material, or kit of any one of the preceding embodiments, wherein the radical photoinitiator is a Norrish Type I Photoinitiator.

34. The combination, build material, or kit of any one of the preceding embodiments, wherein the radical photoinitiator is a Norrish Type II Photoinitiator.

35. The combination, build material, or kit of any one of the preceding embodiments, further comprising a co-photoinitiator.

36. The combination, build material, or kit of any one of the preceding embodiments, wherein the curing catalyst is activated by a thermal free radical initiator.

37. The combination, build material, or kit of any one of the preceding embodiments, further comprising a stabilizer.

38. The combination, build material, or kit of any one of the preceding embodiments, wherein the stabilizer is a thermal stabilizer.

39. The combination, build material, or kit of any one of the preceding embodiments, further comprising an impact modifier.

40. The combination, build material, or kit of any one of the preceding embodiments, further comprising a radical polarity reversal catalyst.

41. The combination, build material, or kit of any one of the preceding embodiments, further comprising an antioxidant.

42. The combination, build material, or kit of any one of the preceding embodiments, further comprising a primary antioxidant.

43. The combination, build material, or kit of embodiment 42, wherein the primary antioxidant is a benzene polyol.

44. The combination, build material, or kit of embodiment 43, wherein the benzene polyol is a compound of Formula (A-I):

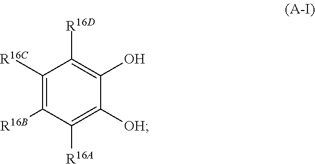

or a salt thereof, wherein:
each of R^{16A}, R^{16B}, R^{16C}, and R^{16D} is independently H, a halogen, cyano, —OR¹⁷, —SR¹⁷. —C(═O)—R⁷, —C(═O)—OR¹⁷, —O—C(═O)—R⁷, —C(═O)—N(R⁷)₂, —C(═O)—NHR¹⁷, —NH—C(═O)—R¹⁷, —N(R¹⁷)₂, —Si(R¹⁷)₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R¹⁷; and
each R¹⁷ is independently H, a halogen, cyano, —OH, —NH₂, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl.

45. The combination, build material, or kit of embodiment 44, wherein at least one of the R^{16A}, R^{16B}, R^{16C}, and R^{16D} is H.

46. The combination, build material, or kit of embodiment 44 or embodiment 45, wherein at least one of the R^{16A}, R^{16B}, R^{16C}, and R^{16D} is the halogen, cyano, —OR¹⁷, —SR¹⁷, —C(═O)—R¹⁷, —C(═O)—OR¹⁷, —O—C(═O)—R¹⁷, —C(═O)—N(R¹⁷)₂, —C(═O)—NHR¹⁷, —NH—C(═O)—R¹⁷, —N(R¹⁷)₂, —Si(R¹⁷)₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R¹⁷.

47. The combination, build material, or kit of any one of embodiments 42-46, wherein the primary antioxidant is a catechol.

48. The combination, build material, or kit of embodiment 47, wherein the catechol is 4-tert-butylcatechol.

49. The combination, build material, or kit of embodiment 47, wherein the catechol is 3,5-di-tert-butylcatechol

50. The combination, build material, or kit of any one of embodiments 42-49, wherein the primary antioxidant is present in the combination, build material, or kit in a concentration of between about 1 and about 10,000 ppm mol/mol, between about 1 and about 8,000 ppm mol/mol, between about 100 and about 6,000 ppm mol/mol, between about 100 and about 5,000 ppm mol/mol, between about 500 and about 5,000 ppm mol/mol, between about 500 and about 4,000 ppm mol/mol, between about 500 and about 3,000 ppm mol/mol, between about 500 and about 2,500 ppm mol/mol, between about 1,000 and about 2,000 ppm mol/mol, or about 1,500 ppm mol/mol.

51. The combination, build material, or kit of any one of the preceding embodiments, further comprising a secondary antioxidant.

52. The combination, build material, or kit of any one of the preceding embodiments, further comprising a catalyst inhibitor.

53. The combination, build material, or kit of any one of the preceding embodiments, further comprising a synergist.

54. The combination, build material, or kit of any one of the preceding embodiments, further comprising a photosensitizer.

55. The combination, build material, or kit of any one of the preceding embodiments, further comprising a photobase generator.

56. The combination, build material, or kit of any one of the preceding embodiments, wherein the combination, build material, or kit does not comprise a photobase generator.

57. The combination, build material, or kit of any one of the preceding embodiments, further comprising a pigment, a dye, or a combination thereof.

58. The combination, build material, or kit of any one of the preceding embodiments, further comprising a surface active agent, a filler, a pigment, a dispersant, or any combination thereof.

59. The build material or kit of any one of the preceding embodiments, wherein the build material has a viscosity ranging from about 1 cp to about 100 cp, from about 2 cp to about 80 cp, from about 3 cp to about 70 cp, from about 4 cp to about 60 cp, from about 5 cp to about 50 cp, from about 6 cp to about 40 cp, from about 7 cp to about 30 cp, or from about 8 cp to about 20 cp as measured at a temperature of about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 110° C., about 120° C., about 130° C., about 140° C., or about 150° C.

60. The build material or kit of any one of the preceding embodiments, wherein the viscosity of the build material varies by about 10 cp or less, about 9 cp or less, about 8 cp or less, about 7 cp or less, about 6 cp or less, about 5 cp or less, about 4 cp or less, about 3 cp or less, about 2 cp or less, or about 1 cp or less, upon storage for two weeks at a temperature of about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 110° C., about 120° C., about 130° C., about 140° C., or about 150° C.

61. The build material or kit of any one of the preceding embodiments, wherein the cured build material has a tensile strength of about 20 MPa, about 25 MPa, about 30 MPa, about 35 MPa, about 40 MPa, about 45 MPa, about 50 MPa, about 55 MPa, about 60 MPa, about 65 MPa, about 70 MPa, about 75 MPa, about 80 MPa, about 85 MPa, about 90 MPa, about 95 MPa, about 100 MPa, or any range therebetween.

62. The build material or kit of any one of the preceding embodiments, wherein the cured build material has an elongation at break of about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 100%, about 105%, about 110%, about 115%, about 120%, about 125%, about 130%, or any range therebetween.

63. The build material or kit of any one of the preceding embodiments, wherein the cured build material has a Young's modulus of about 0.8 GPa, about 0.9 GPa, about 1.0 GPa, about 1.1 GPa, about 1.2 GPa, about 1.3 GPa, about 1.4 GPa, about 1.5 GPa, about 1.6 GPa, about 1.7 GPa, about 1.8 GPa, about 1.9 GPa, about 2.0 GPa, about 2.1 GPa, about 2.2 GPa, about 2.3 GPa, about 2.4 GPa, about 2.5 GPa, about 2.6 GPa, about 2.7 GPa, about 2.8 GPa, about 2.9 GPa, about 3.0 GPa, or any range therebetween.

64. The build material or kit of any one of the preceding embodiments, wherein the cured build material has a notched Izod impact strength of about 5 J/m, about 10 J/m, about 20 J/m, about 30 J/m, about 40 J/m, about 50 J/m, about 100 J/m, about 150 J/m, about 200 J/m, about 250 J/m, about 300 J/m, about 350 J/m, about 400 J/m, about 450 J/m, about 500 J/m, about 550 J/m, about 600 J/m, about 650 J/m, about 700 J/m, about 750 J/m, about 800 J/m, or any range therebetween.

65. A method of preparing a cured material, comprising a step of subjecting the combination, build material, or kit of any one of the preceding embodiments to a curing condition.

66. The combination, build material, or kit of any one of the preceding embodiments for use in preparing a cured material, wherein the preparation comprises a step of subjecting the combination, build material, or kit to a curing condition.

67. Use of the combination, build material, or kit of any one of the preceding embodiments in the manufacture of a cured material, wherein the manufacture comprises a step of subjecting the combination, build material, or kit to a curing condition.

68. The method, combination, build material, kit, or use of any one of the preceding embodiments, wherein the build curing condition comprises electromagnetic irradiation.

69. The method, combination, build material, kit, or use of any one of the preceding embodiments, wherein the build curing condition comprises an elevated temperature.

70. The method, combination, build material, kit, or use of any one of the preceding embodiments, wherein the build curing condition comprises a chemical activation.

71. A cured material being prepared by the method of any one of the preceding embodiments.

72. A method of printing an object using the method, combination, build material, kit, or use of any one of the preceding embodiments.

73. The combination, build material, or kit of any one of the preceding embodiments for use in printing an object.

74. The method, combination, build material, or kit of any one of the preceding embodiments, wherein the printing comprises
(i) depositing the build material; and
(ii) subjecting the deposited build material to a curing condition.

75. The method, combination, build material, or kit of any one of the preceding embodiments, wherein the printing comprises:
(i) depositing the first build material, and the second build material; and
(ii) subjecting the deposited first build material and deposited second build material to a curing condition.

76. The method, combination, build material, or kit of any one of the preceding embodiments, wherein the printing further comprises repeating the step of depositing the material for one or more time.

77. The method, combination, build material, or kit of any one of the preceding embodiments, wherein the printing comprises
(i) providing the build material and
(ii) providing an energy source to activate the radical initiator.

78. The method, combination, build material, or kit of any one of the preceding embodiments, wherein the printing comprises exposing the build material to an energy source (e.g., a light source, e.g., UV light).

79. The method, combination, build material, or kit of any one of the preceding embodiments, wherein the printing further comprises optically sensing the deposited material, and controlling the one or more repeated deposition of the material according to the sensing.

80. A system for 3D printing, comprising:
(i) a printer; and
(ii) an ink comprising the combination of any one of the preceding embodiments.

What is claimed is:

1. A combination comprising:
(i) a ring-opening-metathesis-polymerization (ROMP) precursor;
(ii) a latent curing catalyst; and
(iii) a free radical initiator.

2. A build material comprising the combination of claim 1.

3. A kit comprising the combination of any one of the preceding claims.

4. The combination, build material, or kit of any one of the preceding claims, wherein the ROMP precursor is a compound of Formula (M-I): 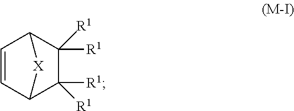
or a salt thereof, wherein:
X is CH₂ or O;
each R¹ independently:
(a) is H, halogen, cyano, —OR^{1A}, —SR^{1A}, —C(═O)—R^{1A}, —C(═O)—OR^{1A}, —O—C(═O)—R^{1A}, —C(═O)—N(R^{1A})₂, —C(═O)—NHR^{1A}, —NH—C(═O)—R^{1A}, —N(R^{1A})₂, —Si(R^{1A})₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1A}; or
(b) together with another R¹ and the atoms to which they attach, form a bond, C₃-C₂₀ cycloalkyl, C₆-C₂₀ aryl, 3- to 20-membered heterocycloalkyl, or 5- to 20-membered heteroaryl, wherein the C₃-C₂₀ cycloalkyl, C₆-C₂₀ aryl, 3- to 20-membered heterocycloalkyl, or 5- to 20-membered heteroaryl is optionally substituted with one or more R^{1A};
each R^{1A} independently:
(a) is H, halogen, cyano, —OR^{1B}, —SR^{1B}, —C(═O)—R^{1B}, —C(═O)—OR^{1B}, —O—C(═O)—R^{1A}, —C(═O)—N(R^{1B})₂, —C(═O)—NHR^{1B}, —NH—C(═O)—R^{1B}, —N(R^{1B})₂, —Si(R^{1B})₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1B}; or
(b) together with another R^{1A} and the atoms to which they attach, form a bond, C₃-C₂₀ cycloalkyl, C₆-C₂₀ aryl, 3- to 20-membered heterocycloalkyl, or 5- to 20-membered heteroaryl, wherein the C₃-C₂₀ cycloalkyl, C₆-C₂₀ aryl, 3- to 20-membered heterocycloalkyl, or 5- to 20-membered heteroaryl is optionally substituted with one or more R^{1B};
each R^{1B} independently is H, halogen, cyano, —OR^{1C}, —SR^{1C}, —C(═O)—R^{1C}, —C(═O)—OR^{1C}, —O—C(═O)—R^{1C}, —C(═O)—N(R^{1C})₂, —C(═O)—NHR^{1C}, —NH—C(═O)—R^{1C}, —N(R^{1C})₂, —Si(R^{1C})₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1C};
each R^{1C} independently is H, halogen, cyano, —OR^{1D}, —SR^{1D}, —C(═O)—R^{1D}, —C(═O)—OR^{1D}, —O—C(═O)—R^{1D}, —C(═O)—N(R^{1D})₂, —C(═O)—NHR^{1D}, —NH—C(═O)—R^{1D}, —N(R^{1D})₂, —Si(R^{1D})₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R^{1D}; and
each R^{1D} independently is H, halogen, cyano, —OH, —NH₂, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl.

5. The combination, build material, or kit of any one of the preceding claims, wherein the ROMP precursor is a compound of: 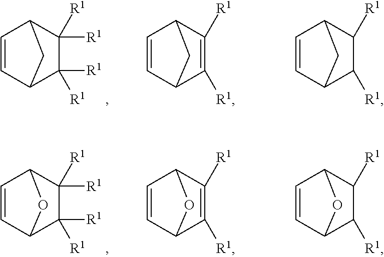
or a salt thereof.

6. The combination, build material, or kit of any one of the preceding claims, wherein the ROMP precursor is a compound of: 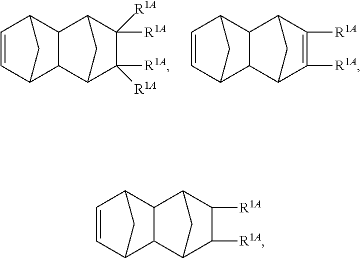
or a salt thereof.

7. The combination, build material, or kit of any one of the preceding claims, wherein the ROMP precursor is a compound of: 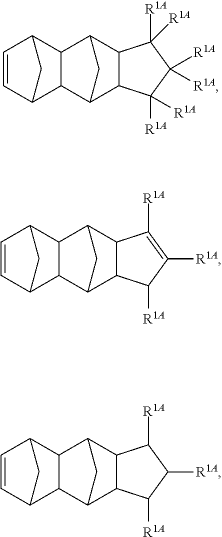
or a salt thereof.

8. The combination, build material, or kit of any one of the preceding claims, wherein the curing catalyst is a compound of formula (C-I): 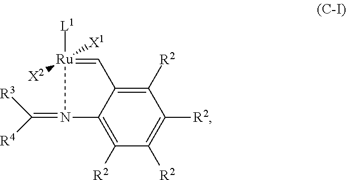
L¹ is 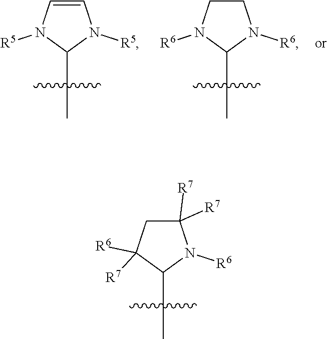
X¹ and X² are each independently halogen, C₁₋₂₄alkoxy, or thiolate;
Each R² is independently hydrogen, halogen, OH, C₁₋₂₄alkyl, C₁₋₂₄alkoxy, C₁₋₂₄ fluoroalkyl, C₁₋₂₄fluoroalkoxy, C₁₋₂₄alkylhydroxy, C₁₋₂₄alkoxyhydroxy, C₁₋₂₄fluoroalkylhydroxy, C₁₋₂₄fluoroalkoxyhydroxy, C₃-C₂₀ cycloalkyl, C₆-C₂₀ aryl, 3- to 20-membered heterocycloalkyl, 5- to 20-membered heteroaryl, NO₂, NR⁸R⁹, OC(O)R¹⁰, C(O)OR¹⁰, NR¹¹C(O)R¹⁰, C(O)NR¹¹R¹⁰, cyano, nitro, silyl, or phosphonyl;
R³ is hydrogen, C₁₋₂₄alkyl, C₃-C₂₀ cycloalkyl, C₆-C₂₀ aryl, 3- to 20-membered heterocycloalkyl, 5- to 20-membered heteroaryl, OC(O)R¹², C(O)OR¹², NR¹³C(O)R¹², or C(O)NR¹²R¹³,
R⁴ is hydrogen, C₁₋₂₄alkyl, C₃-C₂₀ cycloalkyl, or C₆-C₂₀ aryl;
Each R⁵ is independently C₆-C₂₀ aryl wherein the aryl is optionally substituted by one or more R¹⁴;
Each R⁶ is independently C₁₋₂₄alkyl or C₆-C₂₀ aryl, wherein the alkyl or aryl is optionally substituted by one or more R¹⁴;
Each R⁷ is independently hydrogen or C₁₋₂₄alkyl wherein the alkyl is optionally substituted by one or more R¹⁴; and
Each R⁸, R⁹, R¹⁰, R¹¹, R¹², R¹³ and R¹⁴ is independently hydrogen, C₁₋₂₄alkyl, C₃-C₂₀ cycloalkyl, or C₆-C₂₀ aryl.

9. The combination, build material, or kit of any one of the preceding claims, wherein the curing catalyst is a compound of formula (C-II): 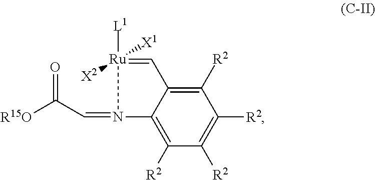
wherein R¹⁵ is hydrogen, C₁₋₂₄alkyl, C₃-C₂₀ cycloalkyl, C₆-C₂₀ aryl, 3- to 20-membered heterocycloalkyl, or 5- to 20-membered heteroaryl.

10. The combination, build material, or kit of any one of the preceding claims, wherein the curing catalyst is activated by a radical photoinitiator.

11. The combination, build material, or kit of any one of the preceding claims, wherein the radical photoinitiator is a Norrish Type I Photoinitiator.

12. The combination, build material, or kit of any one of the preceding claims, wherein the radical photoinitiator is a Norrish Type II Photoinitiator.

13. The combination, build material, or kit of any one of the preceding claims, further comprising a stabilizer.

14. The combination, build material, or kit of any one of the preceding claims, further comprising an impact modifier.

15. The combination, build material, or kit of any one of the preceding claims, further comprising a radical polarity reversal catalyst.

16. The combination, build material, or kit of any one of the preceding claims, further comprising an antioxidant.

17. The combination, build material, or kit of any one of the preceding claims, further comprising a primary antioxidant.

18. The combination, build material, or kit of claim 42, wherein the primary antioxidant is a benzene polyol.

19. The combination, build material, or kit of claim 43, wherein the benzene polyol is a compound of Formula (A-I): 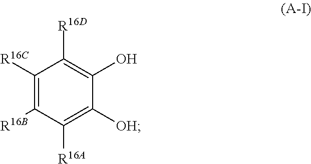
or a salt thereof, wherein:
each of R^{16A}, R^{16B}, R^{16C}, and R^{16D} is independently H, a halogen, cyano, —OR¹⁷, —SR¹⁷, —C(═O)—R¹⁷, —C(═O)—OR¹⁷, —O—C(═O)—R¹⁷, —C(═O)—N(R¹⁷)₂, —C(═O)—NHR¹⁷, —NH—C(═O)—R¹⁷, —N(R¹⁷)₂, —Si(R¹⁷)₃, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl, wherein the C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl is optionally substituted with one or more R¹⁷; and
each R¹⁷ is independently H, a halogen, cyano, —OH, —NH₂, C₁-C₂₀ alkyl, C₂-C₂₀ alkenyl, C₂-C₂₀ alkynyl, C₃-C₂₀ cycloalkyl, C₆-C₂₀ aryl, 3- to 20-membered heterocycloalkyl, or 5- to 20-membered heteroaryl.

20. The combination, build material, or kit of any one of claims 42-46, wherein the primary antioxidant is a catechol.

21. The combination, build material, or kit of any one of claims 42-49, wherein the primary antioxidant is present in the combination, build material, or kit in a concentration of between about 1 and about 10,000 ppm mol/mol, between about 1 and about 8,000 ppm mol/mol, between about 100 and about 6,000 ppm mol/mol, between about 100 and about 5,000 ppm mol/mol, between about 500 and about 5,000 ppm mol/mol, between about 500 and about 4,000 ppm mol/mol, between about 500 and about 3,000 ppm mol/mol, between about 500 and about 2,500 ppm mol/mol, between about 1,000 and about 2,000 ppm mol/mol, or about 1,500 ppm mol/mol.

22. The combination, build material, or kit of any one of the preceding claims, wherein the combination, build material, or kit does not comprise a photobase generator.

23. A method of preparing a cured material, comprising a step of subjecting the combination, build material, or kit of any one of the preceding claims to a curing condition.

24. The combination, build material, or kit of any one of the preceding claims for use in preparing a cured material, wherein the preparation comprises a step of subjecting the combination, build material, or kit to a curing condition.

25. Use of the combination, build material, or kit of any one of the preceding claims in the manufacture of a cured material, wherein the manufacture comprises a step of subjecting the combination, build material, or kit to a curing condition.

26. A cured material being prepared by the method of any one of the preceding claims.

27. A method of printing an object using the method, combination, build material, kit, or use of any one of the preceding claims.

28. The combination, build material, or kit of any one of the preceding claims for use in printing an object.

29. The method, combination, build material, or kit of any one of the preceding claims, wherein the printing comprises
(i) depositing the build material; and
(ii) subjecting the deposited build material to a curing condition.

30. The method, combination, build material, or kit of any one of the preceding claims, wherein the printing comprises
(i) providing the build material and
(ii) providing an energy source to activate the radical initiator.

31. The method, combination, build material, or kit of any one of the preceding claims, wherein the printing comprises exposing the build material to an energy source (e.g., a light source, e.g., UV light).

32. The method, combination, build material, or kit of any one of the preceding claims, wherein the printing further comprises optically sensing the deposited material, and controlling the one or more repeated deposition of the material according to the sensing.

33. A system for 3D printing, comprising:
(i) a printer; and
(ii) an ink comprising the combination of any one of the preceding claims.
